(19) United States
(12) Patent Application Publication
(10) Pub. No.: US 2003/0182944 A1
(43) Pub. Date: Oct. 2, 2003

(54) Highly supercharged gas-turbine generating system

(76) Inventors: John S. Hoffman, Washington, DC (US); William L. Kopko, Springfield, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/397,217

(22) Filed: Mar. 27, 2003

Related U.S. Application Data
(60) Provisional application No. 60/368,987, filed on Apr. 2, 2002.
(60) Provisional application No. 60/382,753, filed on May 22, 2002.
(60) Provisional application No. 60/431,616, filed on Dec. 8, 2002.

(51) Int. Cl. F02C 6/18

(52) U.S. Cl. 60/772; 60/39.182

(57) ABSTRACT

A highly supercharged gas-turbine generation system include a gas turbine power plant that is supercharged to a high inlet pressure, preferably over about 1.15 pressure ratio and preferably includes a transmission system with refrigerated transformers for increased output. The gas turbine power plant includes a precompressor that supercharges to a design pressure ratio of about 1.20 to 10, with a preferred pressure ratio of about 2. For high supercharging pressures, a pressure-reducer is located downstream of the gas turbine to maintain turbine outlet pressure that is close to the inlet pressure. The pressure-reducer is preferably an expander, but can alternatively be an orifice. A torque-limiting coupling on the shaft between the gas turbine and the generator prevents transient overload of the shaft. Capacity of the gas turbine plant is preferably controlled by varying supercharging pressure. The expander preferably has variable-pitch blades to allow efficient variation of turbine outlet pressure. For combined-cycle embodiments, a heat-recovery steam generator (HRSG) may be placed between the gas turbine and a downstream expander. For highest combined cycle output, a single-pressure steam system with high inlet temperature to the HRSG is preferred. The high temperature is preferably provided by supplemental firing between the gas turbine and the HRSG. An expander may be inserted between the supplemental firing and the HRSG to further improve cycle efficiency and to reduce pressure in the HRSG. For retrofit applications with limited supercharging, a refrigeration system for generator cooling may be added to increase generator output to match that available from the supercharged gas turbine.

Applicants claim benefit of provisional application No. 60/368,987, entitled “High-Output Gas-Turbine Power Plant,” filed on Apr. 2, 2002, provisional application No. 60/382,753, entitled “High-pressure supercharging system”, filed on May 22, 2002, and provisional application No. 60/431,616, entitled “High-Output Gas-Turbine Power Plant,” filed on Dec. 8, 2002.

### BACKGROUND—FIELD OF INVENTION

The invention is in the field power generation systems, specifically gas turbines and combined-cycle plants with high-pressure supercharging and cooling systems.

### BACKGROUND—DESCRIPTION OF PRIOR ART

A basic problem with performance of power-transmission and generation systems is that the peak demand on such systems usually occurs during a maximum ambient temperature condition, which corresponds to a maximum air-conditioning load, while the capacity of the generators and transformers generally decreases as ambient temperature increases. In addition, prime movers such as combustion turbines and combined-cycle plants generally have reduced power capacity at higher ambient temperature conditions. This problem means that the system capacity is lowest at the same the demand is the highest. Consequently, power generation and transmission systems designed to meet anticipated peak demands for power at maximum ambient temperature conditions by definition will have an excess capacity at lower ambient temperatures (when demand is lower) that is simply wasted.

Gas-turbine power plants and related power transmission systems have undergone an intense period of development and improvement over a period of at least 60 years. Billions of dollars have been spent on improvements in materials, aerodynamics, and other aspects of the engines that have improved efficiency, capacity, and reliability of gas turbines. In addition, design and construction engineers have put a huge effort in optimizing the design and construction of simple-cycle and combined-cycle power plants to minimize first cost and ongoing operating costs of these systems. Many of these improvements have been achieved through a long series of relatively small, incremental changes over a period of decades. For a more complete description of the history of improvements see, for example, Brandt et al, “GE Gas Turbine Design Philosophy”, 1994. However, none of these efforts has addressed the problem of reduced capacity during peak demand at maximum ambient temperatures as explained above.

Combustion turbine systems, particularly combined-cycle plants, have become the first choice among power generation companies for developing new generation stations. Reasons for this dominance include: lower first cost than other types of power plants, excellent efficiency, greatly improved environmental performance, relative ease of siting, quicker construction, and quick return on investment.

Despite these advantages, developing combined-cycle plants face difficulties. Increased price volatility and increasing resistance to power-plant siting produce a strong need for further reductions in the cost of building new plants. They also produce a need for increasing the efficient use of available land to gain greater power output from available sites.

Cooling of turbine inlet air, especially using evaporative coolers or foggers, has seen widespread use. These systems improve the capacity of gas turbines at high ambient temperatures by reducing the inlet air temperature. Evaporative cooling systems or foggers can achieve as much as a 10% increase in capacity in desert climates, but provide a much smaller advantage in humid climates. Chilling systems can provide more of a capacity increase but are limited to cooling to a temperature of about 45 to 50° F. to prevent possible icing problems. Overspray and water injection system have also been used and can achieve significant capacity increases of up to 20 to 25% in some cases, but potential compressor damage and flame stability issues frequently limit the available output to smaller increases.

An approach that has seen limited use is supercharging. Supercharging has the advantage of being able to provide a much larger improvements in gas-turbine output than can be achieved by inlet cooling. Supercharging of combustion turbines dates back to the 1960s. Foster-Pegg's article from this period describes a typical configuration of early designs. The typical design static pressure rise was about 60 inches of water (1.15 pressure ratio at sea level) in combination with an evaporative cooler between a supercharging fan and the inlet to a gas turbine.

Foster-Pegg (U.S. Pat. No. 3,796,045) describes a supercharging system in combination with a refrigeration system that is driven using thermal energy from the exhaust from the gas turbine. The examples in this patent show a system that supercharges to a pressure of about 60 inches of water with the refrigeration system cooling turbine inlet air to a temperature of about 40° F.

This system is complicated and requires the use of expensive steam-driven refrigeration equipment. In addition, the system requires the use of a steam power that could be used to generate electricity, which is a real disadvantage for modern combined-cycle power plants. For these reasons, the Foster-Pegg system has not been commercialized.

Bronicki et al (U.S. Pat. No. 6,332,321) teaches an alternative system that cools turbine inlet air to a temperature near ambient temperature using an indirect cooling system in combination with supercharging to a pressure ratio of about 1.15. The indirect cooling system uses a secondary refrigerant, such as water or brine, through a coil or a direct-contact heat exchanger in the air stream leaving the supercharging fan. A chiller or cooling tower cools the secondary refrigerant. Bronicki further describes the use of a constant inlet air temperature with the system.

A problem with Bronicki is that it is unable to fully utilize available turbine capacity. Bronicki specifically teaches that the supercharging pressure ratio should be about 1.15. This limited pressure ratio, combined with the limited inlet cooling, creates an upper limit for the available capacity increase. This limited capacity increase means that Bronicki is unable to increase the turbine capacity to the full value corresponding the shaft torque limit for the gas turbine.

Normal wear and aging of components further reduce turbine capacity and allow a greater corresponding increase in capacity for supercharging. Small changes in the geometry of compressor blades, bearing seals, and other components normally produce significant reductions in gas-turbine output. Total reductions on the order of 3 to 5 percent are common in machines in real-life installations. This performance penalty creates another opportunity for increasing turbine capacity with supercharging.

This limitation of Bronicki is especially great in turbines of modern design because they are much less responsive to inlet pressure rise compared to older designs. For example, a GE 7FA has a capacity increase of only about 0.35% per inch of water while a turbine of 1960s vintage can have capacity increase as high as 0.57% per inch of water. This difference is a result of higher compressor pressure ratios and higher firing temperatures of modem machines.

Another problem with designs found in the prior art is related to size of ducts and heat exchangers used to cooling air exiting the supercharging fan. These systems use evaporative coolers, direct-contact heat exchangers, or cooling coils that have wet surfaces that can shed water drops into the air stream at high face velocities (typically over about 500 fpm). For a large F-class turbine with an airflow rate of approximately 1,000,000 CFM, the cross-sectional area required is about 2000 ft². For a square duct, this area corresponds to a dimension of about 45 feet on each side. In addition, a diffusing section of duct leading to the cooler and a contraction between the cooler and the turbine must be added. All this ductwork must be built to withstand a fan discharge pressure on the order of 60 inches of water. Baffles or other distribution systems may be required to ensure proper air distribution and to prevent excessive local air velocities that can produce liquid carryover. This large duct size creates a large space requirement and greatly increases material and labor costs for assembly of these supercharging systems Electric power plants, transmission, and distribution system represent a huge investment that has taken place over many decades. For design and engineering alone, equipment manufacturers and power companies have devoted tremendously large resources in improving efficiency and capacity while reducing cost of the electrical generating system. Yet despite these investments, there are significant problems that remain.

The effect of ambient temperature on capacity of generators and transformers is another important problem. Most transformers and many generators are cooled with ambient air. Since temperature limits of electrical insulation and related components limit the output of generators and transformers, higher ambient temperatures reduce electrical capacity. These effects can reduce output of these devices by 10 to 20% or more compared to ratings at lower ambient temperatures.

A related problem is a limited ability to increase capacity of electrical equipment to meet changing needs. The design capacity of generators, transformers, gas turbines, etc. is essentially fixed with little room for increasing capacity. For transformers, cooling capacity can be increased through the addition of cooling fans to improved heat transfer, but is otherwise limited by thermal considerations.

A recent trend has been to develop inlet-cooling systems for combustion turbines, which sometimes include generator cooling. These systems are typically use fogging or evaporative cooling for lowering the temperature of air entering the compressor section of the combustion turbine. In recent years mechanical refrigeration systems for chilling inlet air to a low temperature, typically about 45 to 50° F., have been introduced. For some of these systems, a portion of the cooled air is supplied to the generator for the turbine to increase its capacity.

Foster-Pegg (U.S. Pat. No. 3,796,045) describes an alternative system that combines chilling of turbine inlet air with a supercharging and generator cooling. This system uses the same fluid for both cooling inlet air to the combustion turbine and cooling the generator. As with conventional chilling systems, Foster-Pegg limits generator cooling to temperatures that are close to that for the inlet air temperature. Foster-Pegg also lacks a means for cooling the generator without operation of the chiller, which limits operation of the combustion turbine.

A recent major improvement to supercharging involves the use of variable-capacity fans combined with fogging. U.S. Pat. Nos. 6,308,512 and 6,442,942, incorporated in their entirety herein by reference, describe these systems.

In recent years extensive laboratory work has been done on the application of superconduction to electrical equipment. These systems generally require cryogenic cooling to extremely low temperatures, on the order of liquid nitrogen or lower. These cooling systems are complicated, extremely expensive and require specially design insulation in order to function. They are not suitable for use with conventional generators and transformers.

### SUMMARY OF THE INVENTION

In accordance with the present invention, an electric generation system includes a highly supercharged gas turbine. In addition the system preferably includes a high air velocity through the cooler, a pressure-reduction mechanism downstream of the gas turbine, and improved cooling of the electric generators and transformers to provide added power output capacity.

### BRIEF DESCRIPTION OF THE FIGURES

FIG. 1 is a schematic diagram of a first embodiment of the present invention, with an electromechanical transducer that drives a precompressor and an expander for a combined-cycle plant.

FIG. 2 is a schematic diagram of an alternate embodiment of the invention for combined-cycle plants that includes a precompressor and expander on a shaft with no net power output.

FIG. 3 is a schematic diagram of a preferred embodiment of the invention, for a combined-cycle plant or other plant with a heat-recovery steam generator (HRSG).

FIGS. 4A and 4B show alternate embodiments of the system of FIG. 3, with different locations for an expander in relation to a HRSG and duct burner.

FIG. 5 is a schematic diagram of a simple-cycle embodiment according to the invention, which uses a variable orifice as means for reducing pressures for exhaust leaving a gas turbine.

FIG. 6 shows a schematic diagram of yet another alternate embodiment of the invention, which is suitable for retrofitting of existing plants.

FIG. 7 is a schematic diagram of an alternate embodiment of FIG. 6 without a cooler.

FIG. 8 is a schematic diagram of an alternate embodiment of the invention that provides generator cooling that is suitable for use with hydrogen-cooled generators.

FIG. 9A shows a schematic diagram of a preferred embodiment for transformer cooling.

FIGS. 9B and 9C show an alternate embodiment for transformer cooling.

FIG. 10 shows a schematic diagram of a preferred complete electrical generation and transmission system according to the present invention.

### DETAILED DESCRIPTION OF THE PREFERRED EMBODIMENTS

Embodiment with a Motor-drive Precompressor and Expander:

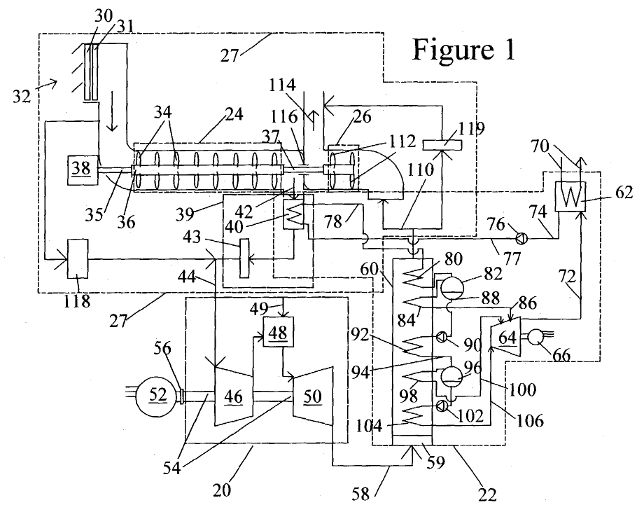

FIG. 1 shows an embodiment of a gas-turbine power generation system according to the invention in a combined-cycle application. The major components of this system are a supercharger 27, a gas turbine 20 and a steam cycle 22 that is driven by waste heat from the gas turbine. The gas turbine 20 is preferably a modified heavy-duty, single-shaft combustion turbine with a design firing temperature of about 2000° F. or higher. The design pressure ratio (combustor absolute pressure to compressor inlet absolute pressure) is typically less than about 20 for these machines. Example combustion turbines of this type include “E” and “F” class turbines and higher such General Electric 7E, 7EA, 7F, 7FA, 7FB for 60 Hz and similar 50 Hz models and Siemens-Westinghouse 501D5A, 501F, 501G. “H” class machines of both of these manufacturers are also possible options. H-class machines incorporate steam cooling of turbine blades with an integral steam cycle. They have a common shaft for both the steam and gas turbine and other internal changes to the steam-cycle and gas turbine from the example shown in FIG. 1.

In addition to the advantages of commercial availability, high-efficiency, high-reliability, and large capacity at low cost per kW of output, machines of this type have a high firing temperature and a relatively low pressure ratio, which allows for a large increase in supercharging while maintaining excellent efficiency.

There are several relatively inexpensive changes that would be desirable for the combustion turbine compared to a conventional unsupercharged design. First, the capacity of the combustor would have to be increased to handle a larger mass flow of fuel and air. For a conventional, unsupercharged turbine the maximum combustor output corresponds that required to provide the design expander inlet temperature at a low ambient temperature at sea level. The minimum design ambient temperature depends on the particular turbine and ranges from about 40° F. to about −40° F. This change to the combustor will also involve tuning the combustion process for the new operating conditions to ensure low levels of production for NOx, CO, and other pollutants. Specific changes to the combustor assembly may include a larger fuel pumping system, different nozzle geometries, etc.

Second, the pressure enclosure for the combustion turbine may have to be strengthened to withstand the higher operating pressures. Third, the shaft may have to be strengthened to handle the higher operating torque. Fourth, the higher operating pressure may affect possible vibration or pressure fluctuations, which may require some tuning of the combustor or other components. Fifth, a torque-limiting coupling between the generator and rotating component of the combustion turbine may need to be provided so as to prevent transient overload of the shaft from an electrical short, lightning, etc. Sixth, stator components in the compressor and expander may need to be strengthened to handle higher forces associated with higher mass flow and higher pressure. Seventh, loading on thrust bearings and/or the bearings themselves may require changes if the inlet pressure of the gas turbine is significantly higher than the outlet pressure with supercharging. These changes should be relatively inexpensive and can be implemented without a great deal of time or effort compared the normal introduction of new generations of gas turbines.

The basic aerodynamics, material, and cooling system for the combustion turbine should remain unchanged. Since the primary forces on expander and compressor blades are typically radial, the increased operating torque has little effect on blade loading and should require little or no change in the mechanical design of the blades. The pressure ratio of the gas-turbine compressor and expander would remain within the normal design limits, which means that no change in the basic aerodynamics should be necessary. The supercharger 27 comprises a precompressor 24 that supplies a pressurized air stream 42 to the gas turbine 20, and an expander 26 that recovers energy from expanding gas leaving a heat-recovery steam generator (HRSG) 60 of the steam cycle 22. The supercharger 27 provides an efficient means for greatly increasing the output of the combined-cycle plant beyond its unsupercharged output. Ambient air 32 enters the supercharger 27 through a filter 30 and an optional evaporative cooler 31. Other techniques of cooling could be used. Possible techniques include indirect evaporative cooling or using cold water from lakes or the sea or from thermal storage systems to cool the air stream directly or through secondary heat exchangers.

The air then goes through the precompressor 24, which preferably comprises multiple variable-pitch axial impeller stages 34. Alternatively, precompressor 24 could also comprise any device to compress air, with or without modulation, by such means as variable-speed drives, inlet vanes, staged fans. Stored air could also be used. The impellers are attached to a hub 36 that includes a variable-pitch mechanism. The hub is attached to a shaft 35 that is connected to an electromechanical transducer 38. The electromechanical transducer is preferably a three-phase induction motor or synchronous motor that drives the precompressor. In addition the precompressor preferably shares a common shaft with the expander 26 that comprises multiple stages of variable-pitch blades 112. The output of the expander offsets most of the energy required to drive the precompressor, which reduces the size of the motor required to drive the precompressor. While the electromechanical transducer normally drives the precompressor, there may be circumstances where the expander supplies more than enough power to drive the precompressor, in which case the transducer will act as a generator.

The design of the precompressor is similar to that for conventional variable-pitch axial fans. Manufacturers of these fans include Howden Power of Naestved, Denmark. These axial fans are one or two-stage machines that are used in large industrial applications. These fans are combined into larger machines with more than two stages to attain the precompressor having a higher pressure ratio. A similar configuration is used for the variable-output expander 26.

The rotational speed of the gas turbine supercharger (precompressor) is normally less than that of the gas turbine. A typical rotational speed is between 900 and 1800 rpm, while a heavy-duty gas turbine would normally rotate at two-pole synchronous speed (3600 rpm for 60 Hz line frequency or 3000 rpm for 50 Hz). The rotational speed of the precompressor is limited by the mechanical stresses that are compatible with a variable-pitch mechanism. The pressure ratio per stage is approximately 1.10 and a stage efficiency of between 85 and 90% is readily available with these machines. Centrifugal fans or compressors could also be used, along with other compressive devices.

There are many alternate possibilities for driving the precompressor. For systems with compressed air storage, stored compressed air can be used to drive the precompressor or to supply compressed air in place of the precompressor. Steam turbine drives or even hydroturbine drives are also options, but not generally preferred.

The precompressor is preferably sized to provide a pressure ratio of at least 1.5. The upper limit of supercharging is set by design limits on the gas turbine, with a pressure ratio of 2 being a reasonable value that requires a minimum of changes to an unsupercharged gas-turbine design and may be within the mechanical limits of existing shafting. A pressure ratio of 2 is achievable with approximately 8 impeller stages.

Much higher supercharging pressures are certainly possible. The plant output is approximately proportional to the pressure ratio, which means a tremendous increase in output is achievable with a relatively small increase in first cost. Ratios of 3 or 4 or more would be preferred once sufficient changes are made to the gas turbine. The supercharging pressure ratios of 10 or even higher are theoretically possible.

A warm pressurized air stream 42 leaves the precompressor and enters an intercooler 39. The intercooler preferably comprises a feedwater-cooled intercooler 40 and an evaporative intercooler 43. The feedwater-cooled intercooler cools the air, which also acts to warm feedwater for the steam cycle. This configuration increases air density and reduces compressor work required inside the gas turbine, while at the same time increasing available thermal energy for the steam cycle. These features act to improve plant output and efficiency.

After the feedwater-cooled intercooler 40, an optional evaporative cooler 43 may be included to further reduce the air temperature. The evaporative intercooler is preferably a fogger. Alternatively it can be an evaporative pad or other system that cools the air by evaporation of water. The evaporative intercooler increases output of the gas turbine, but it may give a worse system efficiency depending on the particular system.

Other designs of intercooling in using ambient air, cooling water, or other cooling systems are also possible. The intercooler may be eliminated without affecting the basic principle of operation of the system, but this option would increase the pressure requirement from the precompressor in order to reach a certain capacity. Elimination of the intercoolers may also necessitate the use of high-temperature materials and/or special cooling systems for the gas turbine compressor, since it would significantly increase air temperatures in the compressor. For these reasons, elimination of the intercoolers in not preferred.

A gas-turbine inlet air stream 44 exits the intercoolers and enters a gas-turbine compressor 46 that is part of the gas turbine 20. The gas-turbine compressor further pressurizes the air stream, which then enters a combustor 48. The combustor burns a fuel 49 to produce hot gas that then enters a gas-turbine expander 50. The gas-turbine expander and the gas-turbine compressor preferably share a common shaft 54 that drives a generator 52.

An optional torque-limiting coupling 56 prevents mechanical overload of the shaft 54, which can occur as a result of lightning strikes or other transients to the generator 52. A torque-limiting coupling can include members that slip or shear when torque exceeds a maximum value and act to protect the shaft from damage from transient overloads. Other protection methods are also possible, including electrical protection or isolation of the generator so as to prevent possible torque overload from lighting, electrical shorts, or other transients.

An exhaust gas stream 58 exits the gas turbine and enters the heat-recovery steam generator (HRSG) 60 of the steam cycle 22. The HRSG preferably includes a duct burner 59 that provides supplemental firing to increase steam-cycle output during peak demand periods. While FIG. 1 shows the HRSG as a part of a steam cycle for generating electric power, the HRSG may also be used to generate steam for use in chemical production, food processing, or other industrial processes. Combinations of electric-power and process-steam production are also desirable in many applications.

The HRSG is generally of conventional design with two changes. First, the housing of the HRSG must withstand a larger-than-normal internal pressure, which may require additional re-enforcement compared to conventional designs. Pressure differences on the order of 10 to 20 psi or higher compared to the atmosphere are contemplated according to the invention, while conventional HRSGs are generally designed for pressure differences on the order of 0.5 psi or less.

The higher HRSG gas pressure should significantly improve heat transfer and thus reduce heat-exchanger size and cost. Higher pressure increases the gas density and corresponding Reynolds number for a given gas velocity. Higher Reynolds number increases heat transfer while decreasing friction factor, which gives a significant improvement of gas-side heat-exchanger performance. Since gas-side heat transfer normally dominates the total thermal resistance, improvement in the gas-side performance translates into a smaller surface requirement and lower material cost for the heat exchanger.

A second difference is that the HRSG receives feedwater from the feedwater-cooled intercooler 40, while conventional systems lack this feature. In addition to the efficiency and capacity benefits discussed earlier, the feedwater-cooled intercooler warms the feed water to prevent possible corrosion from condensation of moisture from the combustion gasses. The higher gas-side pressure for the HRSG increases the water vapor pressure and raises the dewpoint, which means that condensation can occur at somewhat higher temperatures than those found in conventional systems. For example, for an exhaust gas stream at two atmospheres, the dewpoint is about 25° F. higher than that for a stream with the same absolute humidity at one atmosphere.

The steam-cycle shown is a three-pressure system without reheat. A condenser 62 cools low-pressure steam 72 using cooling water 70. The steam condenses to form a liquid stream 74, which is pressurized with pump 76 to form a feedwater stream 77. The feedwater stream 77 enters the feedwater-cooled intercooler 40 where the pressurized air stream leaving the precompressor warms the feedwater. The feedwater then enters a low-pressure boiler 80, which is a part of the HRSG. The low-pressure boiler further heats the feedwater and boils at least a portion of the liquid to form a low-pressure two-phase mixture that enters a first separator 82. The separator 82 separates steam from liquid water. The steam goes through a first superheater 84. The first superheater 84 heats the steam to a temperature well above saturation to form a superheated low-pressure steam stream 86, which is expanded through a steam turbine 64.

The steam cycle further includes medium-pressure and high-pressure components. The liquid exiting separator 82 continues on through a pump 90, which pressurizes it to a medium pressure. The liquid continues through a medium-pressure boiler 92 to form a medium pressure two-phase mixture 94. The medium pressure two-phase mixture enters a second separator 96. The vapor portion of the two-phase mixture exits the separator and is heated in a second superheater 98 to form a medium-pressure superheated steam stream 100, which then expands through the steam turbine 64. The liquid leaving the second separator 96 then goes through a pump 102 and a high-pressure boiler 104. A high-pressure steam stream 106 exits the high-pressure boiler and then enters the steam turbine 64.

The steam cycle 60 is one possible configuration for illustration purposes and can be modified using design and optimization techniques in the prior art. Single-pressure or two-pressure systems are possible. Reheat systems are another option. Various other combinations and configurations are found in the large prior art of steam-cycle and may be used in this system. The optimum configuration involves trade-offs between first-cost, performance, reliability, complexity, etc., which can be evaluated using analytical techniques found in the prior art. An example of a commercially available computer model for doing the technical evaluation includes GateCycle, which is sold by GE Enter.

A pressurized exhaust stream 110 exits the HRSG 60 and enters the expander 26, which is part of the supercharger 27. The expander is preferably of a variable-pitch axial-flow design that is similar to that of the precompressor 34. (Other expanders could be used, including fixed-pitch axial expanders.) Variable-pitch blades 112 are connected to a hub 113, which includes a variable-pitch mechanism. The hub 113 is connected to a shaft 37, which, in turn, is connected to the hub of the precompressor. While the electromechanical transducer normally drives the precompressor, there may circumstances where the expander supplies more than enough power to drive the precompressor, which means the transducer acts as a generator. A seal 116 prevents flow of gasses between precompressor 24 and the expander 26. The seal preferably includes a bearing for supporting shaft 37. Additional bearings may be included as required for support of the precompressor and expander using design techniques found in the prior art.

A low-pressure exhaust stream 114 exits the expander 26 and is preferably discharged to the atmosphere through a stack. An expander bypass damper 119 and a precompressor bypass damper 118 allow inlet and exhaust gas to bypass the supercharger to allow efficient unsupercharged operation. These dampers are optional and can be eliminated without changing the basic operation of the system at full-load conditions. Use of the bypass dampers is most desirable at low-load conditions and allows the steam-cycle to remain near design temperatures for quick ramp-up in capacity. For the embodiment in FIG. 1, the bypass dampers may be simple open-close devices with no capacity for modulating intermediate flows. The precompressor bypass damper 118 may be a check valve that opens in response to a pressure drop in the direction of the turbine inlet without the need for an actuator. A brake may also be included for preventing rotation of the shaft for the supercharger to prevent potential damage to bearings or the variable-pitch mechanisms associated with low-speed rotation (freewheeling).

The design of the expander and any ducts or stacks downstream of the expander must address possible corrosion issues associated with condensation of moisture and/or acids from the exhaust gasses. Possible materials may include stainless steel, plastics, plastic-coated metals, ceramics, or other corrosion-resistant materials. The temperature of gasses leaving expander is low (typically less than 150 to 200° F.), so use of plastic materials and coatings may be a good option, especially in systems that lack the bypass damper.

While not shown in FIG. 1, other options for supercharger capacity control are possible in addition to or in place of the variable-pitch blades for the precompressor and expander. Variable inlet vanes or stator vanes are an option. A variable-speed drive is another alternative. The optimum combination of capacity control depends on the relative cost, efficiency, capacity range, ease of starting, etc. for each control option compared the requirements of the particular installation.

Alternate Embodiment:

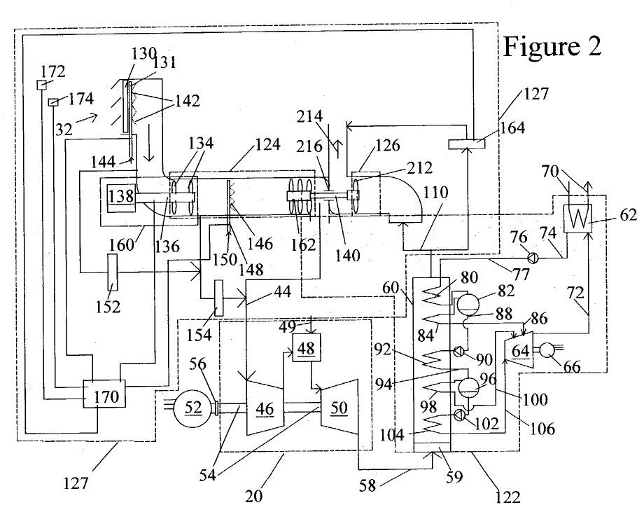

FIG. 2 shows an alternate embodiment of FIG. 1 for combined-cycle plants with a supercharger 127 that comprises a precompressor 124 and an expander 126 on a common shaft 140 without a shaft output. As with the embodiment in FIG. 1, the precompressor 124 pressurizes air to gas turbine 20, which supplies an exhaust stream 58 to a steam cycle 122. The expander 126 receives an exhaust stream 110 from the HRSG 60, which is part of the steam cycle 122. The chief differences are in the design of the precompressor, which is split into a motor-driven, variable-capacity fan and an expander-driven compressor.

Ambient air 32 flows through a filter 130 to a first fogger 131. The first fogger 131 is an array of nozzles that receive demineralized water 144 at high pressure to produce a fine mist 142. The pressure range is on the order of about 1000 to 3000 psig, which allows the production of water droplets in the range of about 5 to 40 microns or smaller. Foggers of this type are commonly used for inlet cooling system for combustion turbines. Example manufacturers/designers of these systems include Mee, Valorbs, and Fern Engineering.

Air leaving the first fogger then enters precompressor 124, which comprises a fan 160 and a compressor 162. The fan shown is a variable-pitch axial fan, but other types of variable-pressure fans could be used. Examples of alternate fans include a variable-speed fan or a fan with variable inlet guide vanes. Variable speed can be provide by a variable-frequency drive in combination with a three-phase induction motor or synchronous motor; a hydraulic clutch; a hybrid electromechanical drive such is in U.S. Pat. No. 5,947,854, incorporated herein by reference; or other means for varying fan speed as is known in the prior art. Another option is to stage multiple fans that connected in series or in parallel so that simply turning the fans on and off changes output pressure. The fan 160 comprises a fan motor 138 that is connected by way of a shaft 137 to a hub 136. The hub 136 contains a variable-pitch mechanism that changes the pitch of fan blades 134. The fan is preferably a two-stage fan to accommodate a pressure difference of up to about 90 inches of water.

Air leaving the fan 160 then flows through a second logger 148. As with the first fogger, the second fogger receives high-pressure water 150 and sprays it in a mist 146. The mist preferably saturates the air and a portion is carried into the compressor 162. The compressor 162 further pressurizes the air. As mentioned earlier, an expander 126 drives the compressor through a shaft 140. A seal 216 ensures that air from the compressor does not leak into an exhaust gas stream 214. The air preferably leaves the compressor near saturation at design conditions and forms a gas-turbine inlet air stream 144. The second fogger thus acts to provide intercooling to reduce compressor energy input.

As with FIG. 1, the expander 126 receives an exhaust gas stream 110 from the HRSG 60. The expander is preferably a single-stage axial expander. Expander blades 212 may be fixed pitch. The expander and compressor rotate together a speed where the power output of the expander is equal to the input power to the expander.

The embodiment of FIG. 2 also includes bypass dampers that allow provide additional control options. A first bypass damper 152 allows air to flow around the fan 160, and a second bypass damper 154 allows air to flow around compressor 162. These bypass dampers together allow the gas turbine to run without the operation of the precompressor 124. These bypass dampers would normally be either fully open or fully close with no need for flow modulation.

In addition a third bypass damper 164 allows for bypass around the expander 126. The third bypass damper preferably includes a means for modulating the amount of flow through the damper in addition to simple open-closed control. In addition to allowing operation of the gas turbine without any significant pressure drop from the expander, movement of the third damper can modulate expander output. For example, bypassing a relatively small amount of flow around the expander will act to reduce the expander's speed and power output. The lower speed translates into a lower output pressure from the compressor 162, which further reduces the available pressure to the expander. The result is a multiplying effect that acts to reduce supercharging pressure to the gas turbine with only a relatively small loss of power through the third bypass damper 164.

A controller 170 is in communication with an ambient temperature sensor 172 and a humidity sensor 174. The controller is preferably in communication with the third bypass damper 164, the fan 160, and the foggers 131 and 148. If less output is required, the controller reduces the fan output pressure, which reduces the inlet pressure to the compressor 162 and reduces the output of the foggers. The controller can also modulate the position of the third bypass damper as discussed above. These changes increase the compressor power required to reach a given pressure of the gas-turbine inlet air stream 144. They also act to reduce the available pressure difference across the expander 212. These changes create a multiplying effect that allows a relatively small change in fan pressure create a large change in gas-turbine inlet pressure. This setup allows the controller to modulate output as required to compensate for changes in ambient temperature conditions or require plant output.

In addition to controlling the inlet pressure to the gas turbine, the controller preferably limits the pressure ratio across the gas turbine expander to a predetermined maximum value, so as to avoid excessive expansion losses and assures optimum efficiency of the system. This limitation can be achieved by adjusting the output of the foggers to maintain approximately a constant temperature to the inlet of the gas turbine or through adjustment of the pressure provided by the fan or combination of these controls.

In this embodiment there is no feedwater-cooled intercooler, since the discharge of the compressor 162 is normally near the feedwater temperature because of the cooling effect of the fog. If a feedwater-cooled intercooler or other sensible cooling system is included, it should be upstream of any fogger or evaporative cooling system associated with the precompressor.

Alternate Combined-Cycle Embodiment:

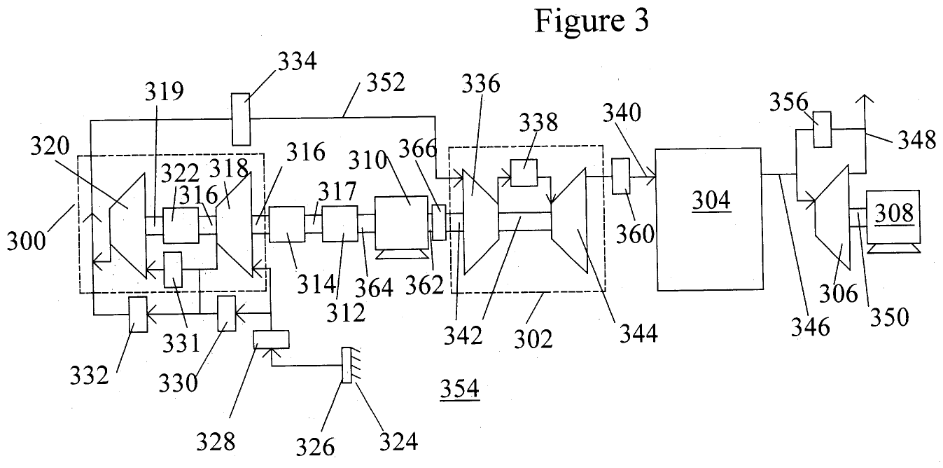

FIG. 3 shows a preferred embodiment for a power plant with a heat-recovery steam generator. A precompressor 300 draws air from the atmosphere 354 and supplies pressurized air 352 to a gas turbine 302. The gas turbine 302 supplies a hot exhaust 340 air stream through a duct burner 360 to a heat-recovery steam generator (HRSG) 304. The gas turbine 302 includes a compressor 336 that receives the pressurized air 352 from the precompressor 300 and supplies compressed air to a combustor 338, which heats the compressed, pressurized air to create a hot gas stream, which expands through a first expander 344. The gas turbine is preferably a modified heavy-duty design similar to that described for FIG. 1. The compressor 336 and the first expander 344 are attached to a common shaft 342 that drives a first generator 310 through a torque-limiting coupling 366 and a generator input shaft 362. A generator output shaft 364 extends beyond the end of the generator 310 that is opposite the gas turbine 302 so as to provide a means for driving the precompressor 352. Shafts 342, 362, and 364 are preferably coupled together and run at the same rotational speed.

A second expander 306 expands a gas stream 346 that exits the HRSG 304. An exhaust stream 348 leaves the second expander and is discharged to the atmosphere. The second expander is connected by way of a shaft 350 to a second generator 308.

The second expander 306 is preferably an axial-flow device with variable-pitch blades. Other alternatives for varying expander capacity include variable inlet vanes or other variable geometry, variable speed control, and staging multiple expanders. The basic mode of control for the second expander is to maintain a gas-turbine output pressure that is close to the inlet pressure.

For a typical pressure ratio of roughly 2.0, the expander may be of a single-stage or two-stage design. The rotational speed of the second expander is preferably less than that of the gas turbine, typically about 600 to 1800 rpm in order to keep tip speed low enough to prevent overload of the variable-pitch mechanism. (Tip speed is the speed of the blade tip in feet per second or meters per second and provides a measure of strength requirements for an impeller.) The materials of construction should be of corrosive-resistant materials such as stainless steel, plastic, titanium, or anodized aluminum so as to prevent damage from acid condensate that may form as gas temperature drops as it flows through the expander.

While a design pressure ratio of the precompressor of about 2.0 is preferred because of the relative ease of modifying the gas turbine at these levels, much higher operating pressures up to 10 or even higher are possible and may be desirable depending on the ease of modifying the design of the gas turbine. For higher pressure ratios addition precompressor stages and/or expander stages may be required. Lower pressure ratios are also possible. Preferably the supercharger pressure and expander pressure ratio are approximately the same, with the expander ratio normally somewhat lower than that of the precompressor. This preferred control is to maintain approximately constant pressure ratio across the gas-turbine expander 344 that corresponds to a maximum design value. The pressure difference between the turbine inlet and outlet can be adjusted to compensate for changes in inlet air temperature to the gas turbine associated with changes in ambient temperature. For the embodiment in FIG. 3, the gas-turbine expander pressure ratio is preferably controlled through a combination of operating selected stages of the precompressor 300 and adjusting the pitch of the blades on the second expander 306.

An expander bypass damper 356 allows operation without the second expander. This damper is normally closed, and opens when the expander is not operating. Opening the expander bypass damper 356 allows gas to exit the HRSG at approximately atmospheric pressure. A brake may be included on the second expander to prevent low-speed rotation (“free-wheeling”) in response to airflow through the expander when it is not operating.

The precompressor 300 preferably comprises multiple compressor stages that may be turned on and off so as to provide control over the inlet pressure to the gas turbine. FIG. 3 shows two stages of compression. A shaft 316 drives a first-stage compressor 318. The shaft 316 is connected to generator output shaft 364 through a speed reducer 312, a shaft 317, and a first clutch 314. The speed reducer 312 preferably comprises a mechanical arrangement of spur gears or planetary gears that reduce the speed of shaft 317 to a value that is less than that of shaft 364. Typical speed reduction ratios are in the range of 2:1 to 6:1 depending on the requirements of the precompressor 300. While FIG. 3 shows that the speed reducer 312 is closer to the generator shaft, the position of speed reducer 312 and the first clutch 314 may be reversed.

The first clutch 314 is of the kind that can engage and disengage from a remote signal so as to allow the precompressor 300 to stop and start while the gas turbine is running. A typical mechanism for this clutch is to provide a hydraulic coupling in parallel with an overrunning clutch. The hydraulic coupling is used to accelerate shaft 316 to a speed that is somewhat higher than that of the input from shaft 317. At that point the overrunning clutch is allowed to engage and the hydraulic coupling is disconnected. The speed of shaft 316 drops until it matches that of shaft 317, at which time the overrunning clutch engages and the two shafts run at the same speed. A means for disengaging the clutch is also provided so as to allow the precompressor to stop while the gas turbine is still running. SSS Clutch of New Castle, Del., USA, is an example supplier of this type of clutch.

When the first clutch 314 is engaged, the first-stage compressor 318 runs when the gas turbine 302 is operating. A second clutch 322 connects the shaft 316 from the first-stage compressor 318 to a shaft 319 that drives a second-stage compressor 320. The design of the second clutch 322 is preferably similar to that of the first clutch 314 except that the torque-transmission requirements are smaller.

The flow of air through the precompressor 300 depends on the operation of the compressor stages and the states of a first bypass damper 330 and a second bypass damper 332. If both stages are operating, then both bypass dampers 330 and 332 are closed. Air from the atmosphere 354 flows through an inlet 324 and a filter 326 to a first cooler 328. The cooler is preferably an evaporative media cooler or a fogger. Air leaves the first cooler 328 and then flows through the first-stage compressor 318, which increases the pressure and temperature of the air. The air then flows through a second cooler 331, which is preferably a fogger, and then through the second-stage compressor 320. The air then leaves the second-stage compressor and flows through a third cooler 334 to produce the pressurized air stream 352, which then flows into the inlet of the gas turbine 302.

If both compressor stages 318 and 320 are not operating, then both bypass dampers 330 and 332 open to allow air to move freely around the compressor stages. In this case most of the incoming air moves from the first cooler 328 through the first bypass damper 330 and then through the second bypass damper 332 and on through the third cooler 334 into the gas turbine 302.

While most of the air moves through the bypass dampers when they are open, some air will flow through the compressor stages. Brakes may be included to keep the compressor stages from rotating at a low speed when they are turned off.

If only the first compressor stage 318 is operating, then the first bypass damper 330 is closed and the second bypass damper 332 is open. Air moves from the first cooler 328, through the first stage compressor 318 and then primarily through the second bypass damper 332 to the third cooler 334.

The first-stage and second-stage compressors are preferably centrifugal compressors with variable inlet vane control. For a total pressure ratio of 2.0, each compressor stage requires about a 1.4 pressure ratio, which is readily achievable using inexpensive high-pressure blowers running at between roughly 900 to 1800 rpm. Alternatively axial compressors may be used, but they may require more stages and/or a higher rotational speed to achieve the same pressure rise.

This embodiment can easily provide a great variation in output while maintaining a high efficiency. For operation at maximum capacity, the bypass dampers 330, 332 and 356 are closed. The first-stage and second-stage compressors 318 and 320 of the precompressor 300 operate at full capacity. Likewise, the first, second, and third coolers 328, 331, and 334 operate at a high capacity to ensure that the inlet air to the compressor 336 of the gas turbine 302 is cooled to the maximum extent possible without risk of damage to the compressor. The vanes on the gas-expander 344 are adjusted to provide a large pressure difference across the expander.

To reduce capacity, the first step is to partially close the vanes on the precompressor 300, which reduces the pressure of the inlet air to the gas turbine. The blade position on the second expander 306 is also adjusted, to maintain approximately the same pressure at the inlet and outlet of the gas turbine.

To further reduce capacity, the second-stage compressor 320 may be turned off and the second bypass damper 332 opened. The first-stage compressor 318 can operate at full open vanes to give a pressure ratio about 40 to 50% of design. Closing the vanes allows operation at an even lower pressure rise. The blades on the second expander 306 should be adjusted to maintain an outlet pressure for the gas turbine that is approximately the same as the gas-turbine inlet pressure.

For minimum capacity the precompressor 300 and second expander 306 can be turned off and all the bypass dampers opened to allow the gas turbine to operate without any supercharging. The output of the plant should be roughly proportional to the supercharging pressure ratio, which means that the unsupercharged output would be about half of the design value for a design supercharging pressure ratio of 2.0. Since this capacity reduction is achieved without reducing firing temperature to the gas turbine, efficiency of the gas turbine and any steam cycle connected to the HRSG should remain close to the design value. Capacity below this level can be modulated by conventional means, such as reduction of firing temperature, which may significantly affect plant efficiency.

Control of the coolers 328, 331, and 334 also provides a means for controlling plant output. For example, at high ambient conditions, the coolers may operate at a high output to maintain a minimized gas-turbine inlet temperature. This operation would typically involve adding moisture to the air stream until a minimum difference between inlet dry-bulb temperature and wet-bulb temperature is reached. This minimum temperature difference would normally correspond to a maximum amount of fog injection that is consistent with essentially zero liquid carryover into the gas turbine's compressor 336. At lower ambient temperatures the output of the coolers can be reduced so as to maintain a constant turbine inlet temperature, which maintains a close to a constant plant output. Operation while varying both inlet pressure and temperature is also possible; the optimum combination of control may depend upon the details of the plant performance characteristics, output requirements, electric and fuel prices, and other factors.

There are numerous variations of this embodiment that may be desirable in some cases. For example, electric motors, steam turbines, gas turbines, or other drivers may be used instead of driving the precompressor from the generator shaft. The advantage of driving from the generator shaft is that it reduces the required generator capacity and also eliminates the need for motors or other drivers. The alternate means of driving the precompressor may have advantages in terms of reliability and flexibility of operation, since the compressor stages can then be operated independently of the gas turbine and each other.

Another possible variation is in the type of cooler used. While foggers are generally preferred because of their relatively low cost and flexibility of operation, other types of coolers may have advantages, especially for high supercharging pressures. For example, a feedwater heater may be used to cool the inlet air to the turbine. (The feedwater heater is a heat exchanger that transfers thermal energy from the air stream to water used to produce steam in the HRSG. This heat exchanger acts to heat the feedwater while cooling the air.) Another alternative is to include a heat exchanger between the gas stream 346 and the air stream 352 to provide inlet cooling while increasing the temperature of gas entering the second expander. Both of these options can improve plant efficiency. They also can reduce or eliminate the need for adding water in the form of fog. Since there is usually a maximum moisture content that is consistent with stable combustor operation, the reduction of water added may be important in cases with high supercharging pressures that require more cooling.

Yet another option is to eliminate the coolers altogether. While operation without the coolers is possible, the capacity of the plant would usually see a large reduction in output. In addition, high inlet temperatures to the compressor 336 may require a redesign to ensure that temperature limits for the high-stage compressor blades are not exceeded.

Alternate Combined-cycle Configurations

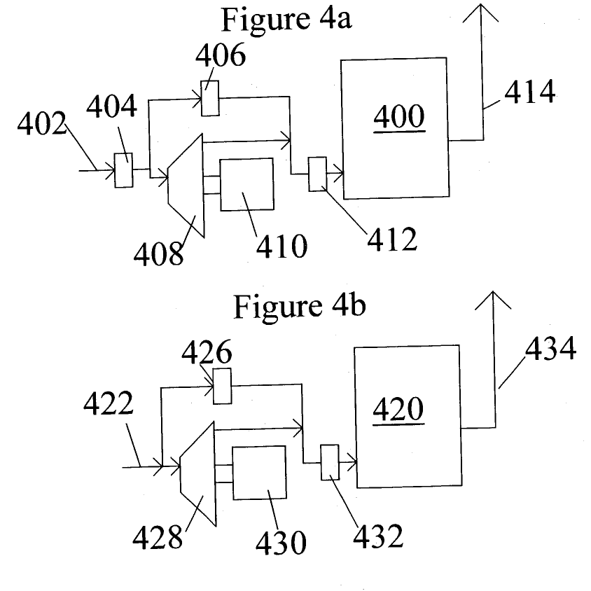

An alternate configuration for the embodiment of FIG. 3 is to move the second expander 306 to a location between the exit of the gas turbine and the HRSG as shown in FIGS. 4a and 4b. In FIG. 4a, a hot gas stream 402 from a supercharged gas turbine enters a first duct burner 404. An expander 408 that drives a generator 410 receives at least a portion of the exhaust stream 402. A bypass damper 406 is in parallel with the expander 408. This bypass damper 406 provides a pathway around the expander when its operation is not required. A second duct burner 412 heats the gas before it enters a heat-recovery steam generator 400. An exhaust stream 414 exits the HRSG and is vented to the atmosphere. This configuration can provide very high-temperature gas to the expander 408 and can thus achieve a high output and cycle efficiency. The second duct burner 412 may be eliminated if the temperature of gas leaving the expander 408 is high enough to provide a high steam output.

FIG. 4b shows a variation on this embodiment, wherein a hot gas stream 422 enters an expander 428 directly from a gas turbine without being first heated by a duct burner. As with FIG. 4a, a bypass damper 426 is in parallel with the expander 428 that drives a generator 430. A duct burner heats 432 heats gas entering an HRSG 420. An exhaust stream 434 exits the HRSG and vents to the atmosphere. This configuration can use lower-temperature material for the expander 428 and thus reduce the material costs, but with reduced output.

Many variations are possible in the location of expander(s) in relation to duct burner(s) and an HRSG. Multiple expanders are an option. Expanders may be located upstream or downstream of a duct burner or downstream of a HRSG and combinations of locations are also possible and may be desirable in some cases. Expanders can drive an electric generator or they can drive the precompressor directly. Variable-speed or variable geometry (variable pitch blades, inlet vanes, etc.) may be used with the expanders to control output and pressure.

In general high temperature gas to the expander increases expander power output and may improve overall cycle efficiency in some cases. The disadvantage is the higher temperatures greatly increase the cost and complexity of the expander because of the need to use expensive high-temperature materials and special cooling systems. The optimum configuration depends on many factors including the relative cost of temperature-resistant materials, space requirements, and overall system efficiency.

Preferred Optimization with Supplemental Firing

Optimum design of a combined-cycle plant depends on the amount of duct firing selected. For minimum cost per unit output, the preferred approach is to design for a large amount of supplemental firing with a single-pressure steam system. Temperatures are approximately 1200 to 2000° F. and preferably about 1800° F. leaving the duct burner. For a discussion of optimum supplemental firing for unsupercharged plants see Rollins, U.S. Pat. No. 6,494,045, incorporated in its entirety herein by reference.

The high level of duct firing works synergistically with the high level of supercharging to provide a massive increase in output compared to a conventional combined-cycle plant. For example a conventional, unsupercharged, combined-cycle plant with an F-class turbine would have an output of 250 MW. With high levels of supplemental firing and a larger steam plant, it is possible to almost double this output to 450 MW. With a high level of supercharging, it is possible to double the plant output again while still using a single gas turbine, to give over three times the output of the base combined cycle plant without duct firing. The supercharging increases the output of the gas turbine and also increases the mass flow through the turbine, which allows for more supplemental firing. The result is a very large output at combined-cycle efficiency, but at prices that approach those of a simple-cycle plant.

An added benefit of this setup is that the varying of the pressure output of the precompressor allows for a large variation of plant output without the need for varying firing temperatures. This approach uses variation in mass flow of the gas turbine to control output, which should maintain good efficiency over a wide range of output values. Varying firing temperature of the duct burner or the gas turbine would only be necessary at low loads when the precompressor is not running. Variation in firing temperature can also modulate output between steps of precompressor pressure control.

Simple-cycle Embodiment

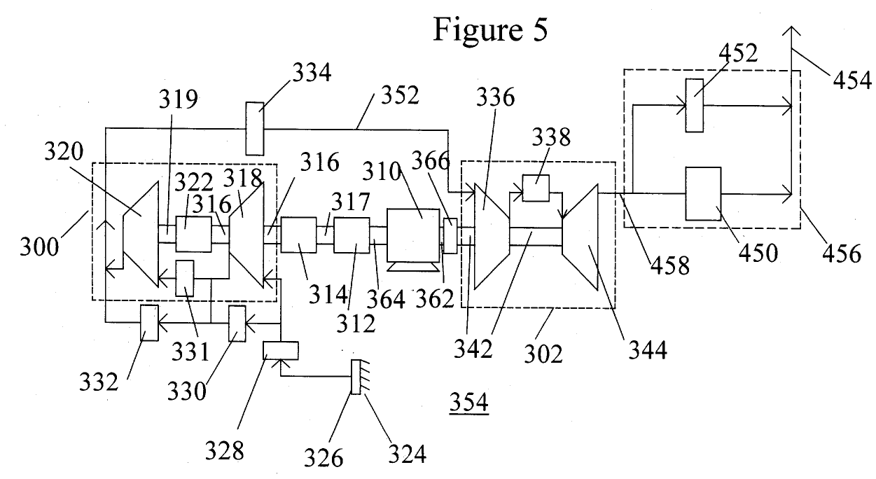

Numerous other variations of the invention are possible without departing from the basic design approach. For example, the HRSG may be eliminated for a simple-cycle application. One example configuration is shown in FIG. 5. In this setup, the gas turbine 302 and the precompressor 300 are the same as described in FIG. 3. The difference is downstream of the gas turbine 302. Instead of an HRSG, a pressure-reducer 456 receives hot gas 458 from the gas turbine 302. The pressure-reducer 456 comprises a fixed orifice 450 in parallel with a bypass damper 452. The orifice 450 has a pressure drop that is preferably somewhat smaller than the pressure rise provided by the precompressor 300. A preferred value of the pressure ratio across the orifice is at least 1.05 and typically about 1.9 or higher. Exhaust 454 exits the pressure-reducer 456 and vents to the atmosphere.

This system allows for a large increase in peak power output for a low capital cost. For unsupercharged operation, the bypass dampers 330, 332, and 452 are opened to allow gas to freely move around the (non-operating) precompressor 300 and the orifice 450 with minimal pressure drop. During periods of high electric demand and/or high electric prices, the precompressor 300 is operated at full capacity as was described for FIG. 3 to increase the inlet pressure to the gas turbine and thereby increase turbine power output. The bypass damper 452 is closed to create a maximum pressure drop. The dimensions of the fixed orifice 450 should be selected to give a pressure drop that is roughly the same or somewhat less than the pressure rise across the precompressor. This operation gives a large increase in the output of the gas turbine, but may have a significant efficiency penalty because of the losses associated with the pressure drop through the orifice.

Operation at intermediate capacity is also possible. For example, operating only the first compressor stage in the precompressor provides an intermediate turbine output. The bypass damper 452 is preferably partially opened to reduce the turbine output pressure to near the inlet pressure.

Simple-cycle configurations with expanders on the gas-turbine outlet are also possible. Likewise, an orifice setup similar to FIG. 5 may be substituted for expanders found in other embodiments disclosed in this specification.

Other simple-cycle configurations are possible. The high exhaust temperature from the gas turbine then means that the expander in the supercharger will have an output that is larger than required to drive the precompressor. This high expander output also means that expander and precompressor may share a common shaft with an electromechanical transducer that would operate primarily as a generator rather than as a motor.

Another approach is to use multiple fans on separate shafts to form a precompressor. This approach allows the use of existing fan design with little or no change. In addition, the supercharger expander can be on a separate shaft and drive a generator. Separating the expander from the precompressor allows for much more flexibility in the location of equipment and can simplify installation in some cases. The disadvantage of a separate shaft for the supercharger expander is the increased cost for the generator and electric motors along with the generator and motor power losses.

Yet another approach is to combine the components of the supercharger into the design of the gas turbine. For example, some or all of the pressure rise from the precompressor may be handled by adding compressor stages to the combustion turbine. Similarly, some or all of the expander pressure drop may be accommodated through changes to the gas-turbine expander. These changes would involve substantial changes to basic design of the combustion turbine and would normally require years of design and testing to implement. It is also more difficult to accommodate intercooling with internal compressor stages. In addition, tip-speed restrictions would limit the compressor diameter if it were tied directly to an extended gas-turbine shaft. This diameter limit, combined with speed limits related to the speed of the gas (i.e., the speed of sound), limits the flow volume and thus the pressure rise and mass flow available using this approach. For these reasons simply extending the existing compressor section of a gas turbine is generally not preferred.

An additional complexity to this approach is that the large volumetric flow rates would be more easily accommodated with a lower rotational speed. A lower rotational speed also allows the use of variable-pitch blades and reduces the potential of damage from impact of water droplets. The use of a lower rotational speed would normally require a new spool of the supercharger compressor and expander or the use of some sort of speed reducer. These problems mean that incorporating the supercharger components into the internal design of the combustion turbine is complex and is not normally preferred.

A Preferred Retrofit Embodiment

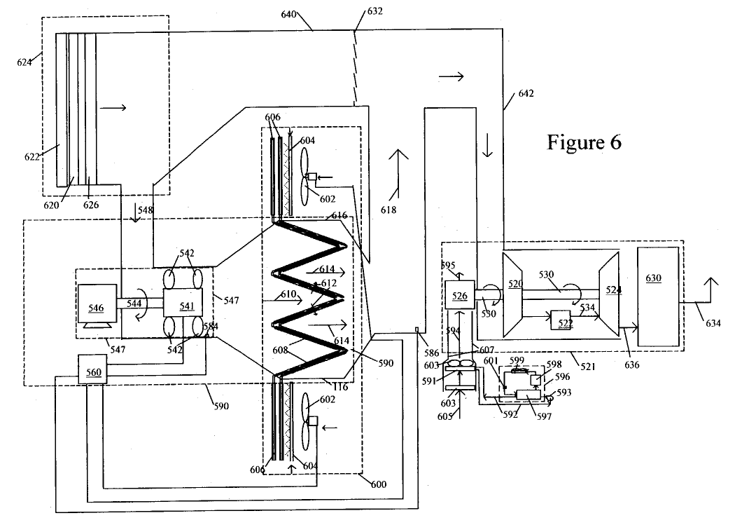

FIG. 6 shows an example of the present invention as applied to an existing conventional combined-cycle power plant. A gas-turbine power plant 521 comprises a combustion turbine 523, a generator 526, and HRSG (heat-recovery steam generator) 630. The combustion turbine comprises a compressor 520 that supplies pressurized air to a combustor 522 to produce heated, compressed gas 534 that expands through an expander 524. The expander 524 is attached to a shaft 530 that drives the compressor 520 and also drives an electric generator 526 attached to an output end of shaft 530.

A turbine exhaust stream 636 enters the HRSG 630 and provides thermal energy to produce steam. The HRSG produces steam that may be used in a steam cycle to drive a steam turbine or in a manufacturing process or combinations of uses. An exhaust stream 634 exits the HRSG and is vented to the atmosphere.

A supercharger 590 comprises a precompressor 547 and a cooler 600. The precompressor is preferably a variable-pitch axial fan. Other options include centrifugal fans, fixed-pitch axial fans, axial-flow compressors, and variable-speed fans or compressors. The precompressor 547 comprises fan blades 542 that are attached to a hub 541. The hub preferably includes a mechanism for varying the pitch of the blades. The hub is attached to a shaft 44 that is driven by an electric motor 546. A steam turbine or gas turbine may be substituted for the electric motor. The rotational speed of the precompressor is normally about 600 to 1800 rpm, which is less than that of the gas turbine.

The precompressor is preferably a multistage, variable-pitch axial fan with a pressure ratio of over 1.15. A preferred design static pressure rise across a two-stage axial fan is on the order of 90 inches of water, which corresponds to a pressure ratio of about 1.22. Higher pressures are preferred for applications where the shaft limit of the turbine and altitude and design ambient conditions allow a higher pressure rise. Two or more fans in series are the preferred way of achieving these higher pressures.

Centrifugal fans or fixed-pitch axial fans are also an option. The precompressor preferably includes some means of varying output pressure. In addition to the option of variable-pitch blades, possible options include variable inlet vanes, variable-speed drives, staging of multiple fans in either a series or parallel configuration, or combinations of these.

In addition, pressure ratios of 4:1 or even higher a possible by adding an expander at the exit of the combustion turbine or the HRSG as was discussed earlier.

The cooler 600 is preferably an indirect evaporative cooler. As shown the cooler comprises fans 602 that move air over a spray header 604 that injects a water spray into the air stream. Evaporation of the water spray cools a heat-pipe heat exchanger 606. Commercially available coolers of this type are available from Colmac Manufacturing of Colville, Wash., USA. Such coolers use a sump and a spray pump to recirculate water over the heat-pipe heat exchanger. A mist eliminator is normally included downstream of the heat pipe heat exchanger to prevent excessive loss of liquid from the system.

Alternatively, the water spray may be in the form of a fog with small droplets with diameters on the order of 10 to 30 microns or smaller using a once-through system with a fogger. The water used in the spray may be from municipal water sources, well sources, or other sources and may require softening or other treatment to minimize corrosion and salt build up on the heat-pipe heat exchanger 606. The addition of a biocide may also be desirable to reduce problems with biological growth and the potential for growth of legionella or other potentially dangerous organisms. Example biocides include chlorine, iodine, ozone, and similar materials that are commonly used in the prior art for cooling towers, evaporative condensers, etc.

The heat-pipe heat exchanger includes a cooling coil 608 that is in an air stream 610 that leaves the supercharging fan 547. The cooling coil 608 cools the air stream 610 to produce a cooled air stream 614. The temperature of the heat pipe is preferably about the dewpoint of the air stream 610 or higher, so that the heat exchange surfaces remain dry to prevent any risk of water carryover into the turbine.

The face of the cooling coil 608 is preferably in the form a “V” shape. The “V” shape allows the face of the cooling coil to be at an angle with respect to the cross-section of a duct 616 that encloses the said cooling coil. The angle reduces the face velocity and pressure drop through the coil. The velocity of an air stream 612 flowing through the cooling coil is reduced by approximately the ratio of the cross sectional area of the duct area to the coil face area. Other arrangements, such as a single straight coil at an angle to the duct are also alternatives. To further reduce duct material requirements, duct 616 has an approximately circular cross-section instead of a rectangular cross-section.

This arrangement provides a major space savings compared to configurations in the prior art. In the prior art, the typical configuration for a cooler is an evaporative pad or wet coil whose face is approximately parallel to the cross-section of the enclosing duct. The conventional configuration limits the average velocity through the duct to about 500 to 600 feet per minute because greater air speeds would blow water off of the cooler surface.

In contrast, the present invention allows a higher face velocity at the cooling coil because the coil has a dry surface. Typical face velocities may be as high as about 1000 to 1200 feet per minute or even higher, depending on the pressure-drop and heat-transfer characteristics of the coil.

In addition, the “V” configuration allows an even higher duct velocity without creating excessive pressure drop. A ratio of cooling-coil face area to duct cross-sectional area on the order of about 1.5 to 6 is preferred. The combination of higher face velocity and compact coil arrangement allow for a duct velocity of about 1000 to 4000 fpm, which is several times that of a conventional system. This higher velocity reduces both in cross-sectional area of the duct and length of duct for diffuser and reducer sections.

An important advantage of a heat pipe is that it greatly reduces or eliminates the risk of liquid hitting the compressor blades in the turbine. Each heat pipe is hermetically sealed and contains only a small charge of working fluid. The working fluid is typically R134a or other material that is a gas at atmospheric pressure and normal working temperatures. This type of working fluid means that any leak immediately flashes to a gas with little or no opportunity for liquid carryover into the turbine. If fluorine content is an issue, materials such as dimethyl ether, propane, isobutane, ammonia, sulfur dioxide, water, alcohol, carbon dioxide, etc. can be used instead. In addition, the many separate circuits mean that the amount of working fluid that can leak from any one leak is very small, which further protects the turbine.

Many other variations on this configuration are possible, but not preferred. For example, a water or brine loop with a circulating pump may replace the heat pipes. This approach has the disadvantage of the potential for liquid leaks into the combustion turbine. Another option is to use air-cooled heat pipes, air-cooled chiller or other mechanical cooling device to provide cooling instead of an evaporative cooler. This approach may be preferred in locations with very limited water supplies, but in most other cases it adds to cost complexity and is not preferred. Other options include cooling with a water-cooled chiller, air-to-air heat exchangers, cooling with river or lake water, or other cooling systems.

A fogger, located either upstream of the fan or downstream of the fan is also an option for cooling air exiting the precompressor. Foggers of this type are commonly used for inlet cooling to gas turbines. A fogger normally uses high-pressure (1000 to 3000 psi) water that flows through small nozzles to produce a fine mist of water droplets with a typical diameter on the order of 30 microns or smaller. The water is preferably demineralized water to prevent carrying damaging minerals into the combustion turbine. If the fogger is located upstream of the fan, water droplets can carry through the fan to provide cooling after the fan. Foggers have the advantage of small size and simplicity, but they require a source of demineralized water, which is not always readily available.

As shown in FIG. 6, the system includes a bypass arrangement for allowing operation of the gas turbine without supercharging. A filter house 624 receives incoming ambient air. The filter house comprises a filter 620, a rain hood 622, and an evaporative cooler 626. The evaporative cooler 626 normally includes honeycomb media with a pump that circulates water over the media surface. Make-up water normally comes from a municipal water supply, well, or other potable-water source. A portion of the circulating water is drained off to prevent excessive accumulation of minerals in the water. A mist eliminate may be included downstream of the media to provide extra insurance against liquid carryover.

During normal operation of the supercharger, filtered air 548 leaves the filter house and enters the supercharger 590. Pressurized air 618 exits the supercharger and goes through a high-pressure duct 642 to the gas turbine. A bypass damper 632 is closed to prevent backflow of air away from the turbine. The bypass damper may be a simple check valve or it may include an actuator to ensure proper operation with minimal leakage.

When supercharging is not required, as during periods of reduced power output or low ambient temperatures, the supercharger 590 can be turned off and the bypass damper 632 opens. Air flows from the filter house 624 through a duct 640, the open bypass damper 632, and then through the high-pressure duct 642 to the gas turbine. A brake is normally included in the precompressor to prevent low-speed rotation during this operation. This configuration minimizes the pressure drop to the gas turbine.

While not normally preferred, the bypass damper and associated duct may be eliminated. Operation of the gas turbine without the supercharger is still possible by drawing air through the precompressor. The pressure drop can be several inches of water, so this configuration is not normally preferred when extended operation without supercharging is required.

A controller 560 is preferably included to ensure proper operation of the system. The controller is preferably in communication with a pressure sensor 584 and a temperature sensor 586 which are located in the air stream supplied to the gas turbine. The pressure sensor is located after the precompressor, while the temperature sensor is located after the cooler.

The embodiment shown in FIG. 6 may be applied to new or existing gas-turbine systems. For new systems, the generator and transmission systems can be selected to handle an approximately flat supercharged output from the combustion turbine and steam cycle. The combustion turbine is preferably modified to increase its shaft torque limit through strengthening the shaft, adding torque-limiting coupling to prevent transient overload, and similar changes.

For existing systems it is frequently desirable cool the electric generators and/or transformers using a chiller or other mechanical cooling systems in order to maximize the available output. This chilling differs from the prior art in that the cooling medium (typically air, water, or hydrogen) is chilled to a temperature that is below that of the turbine inlet air temperature.

In the embodiment as shown in FIG. 6, a preferred cooling configuration is for an air-cooled generator. A cooler 591 cools ambient air 605 and provides a cooled air stream 594 to the generator 526. Heated air 595 leaves the generator and is exhausted to the atmosphere. A fan 603 assists in moving air through the cooler 591. The fan is optional and may be eliminated if the generator has sufficient air moving capacity to overcome any pressure drop from the cooler without an unacceptable reduction in airflow. A filter 603 removes dust and lint from the air to help to prevent clogging of the cooler or the internal channels of the generator. This filter is also optional and can be eliminated if the ambient air is sufficiently clean without filtration. A duct 607 directs air through the cooling cooler 591 to the generator 594. Depending on the particular geometry of the generator, the duct may be unnecessary if the cooler 591 can be mounting in the air inlet to the generator.

The cooler 591 is preferably a cooling coil having a refrigerated fluid circulating inside it. Alternatively, the cooler may be a simple evaporative pad that lowers the air temperature through evaporation of water or a direct-contact heat exchanger. As shown in FIG. 6, the cooler 591 is a coil and receives chilled liquid 592 from a chiller 596. A pump 593 circulates the liquid through the chiller 596 and cooler 591. The liquid is preferably an antifreeze solution or water if winter temperatures are mild enough to prevent risk of freeze damage.

The chiller 596 is preferably a vapor-compression refrigeration system. An evaporator 597 uses boiling refrigerant to cool the chilled liquid 592. A compressor 598 pumps refrigerant vapor from the cooler to a condenser 599, which cools the refrigerant to create refrigerant liquid. As shown in FIG. 6, the condenser 599 is air-cooled, which is preferred for sake of simplicity and reduced maintenance. The refrigerant liquid flows through an expansion device 601 that drops the refrigerant pressure and returns a two-phase mixture to the evaporator 597, which completes the refrigerant circuit.

There are many other options for the refrigeration system. A direct-expansion (DX) coil for cooler 591 may be preferred for small systems. A DX coil serves as an evaporator in a refrigeration loop, which eliminates the need for the chilled liquid loop. A water-cooled or evaporatively cooled chiller may be used instead of the air-cooled chiller to reduce energy use. Ice storage, chilled water storage, or other thermal storage may be incorporated into the system to reduce the need for on-peak power.

Heat-driven cooling systems are a good option if they can use thermal energy from the gas turbine or steam power plant for a reasonable first cost. An absorption chiller may replace a vapor-compression system. The absorption chiller preferably uses exhaust thermal energy from the gas turbine or steam cycle. Other heat-driven systems, such as steam ejectors, desiccant systems, refrigerant ejectors, etc. are possible options.

Alternate Retrofit Embodiment

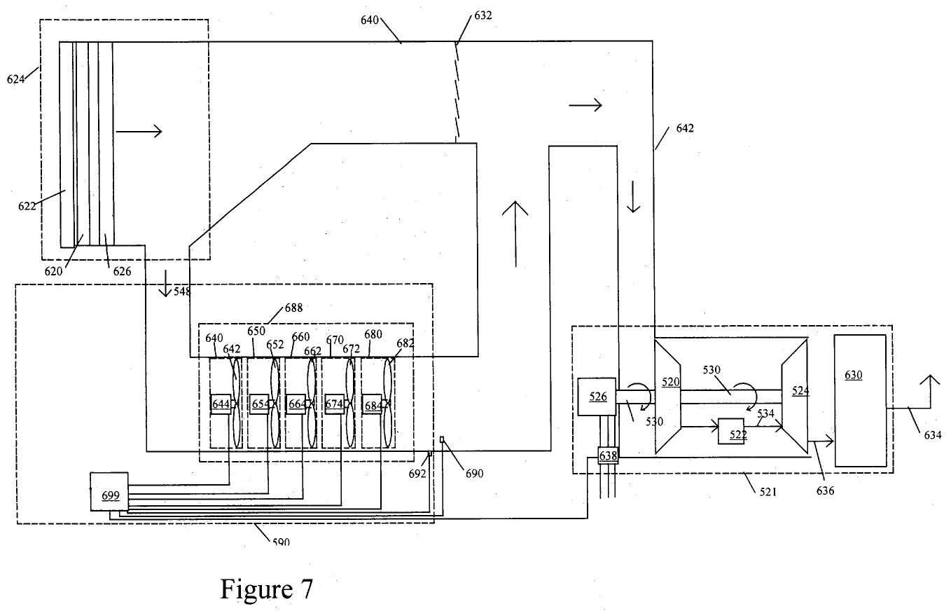

FIG. 7 shows an alternate embodiment of FIG. 6. This embodiment eliminates cooling after a precompressor 688. The precompressor comprises multiple single-stage fans arranged in series. Fans 640, 650, 660, 670, and 680 comprise impellers 642, 652, 662, 672, and 682 that are driven by motors 644, 654, 664, 674, and 684 respectively. The fans are preferably variable-pitch axial fans. Since no cooler is located downstream of the fans, there is no problem with potential liquid carryover into the turbine. If water is unavailable, the evaporative cooler 626 may be eliminated without changing the basic principle of operation of the system.

A controller 699 operates the fans to maximize output of the gas-turbine power plant. A power transducer 638 in communication with the controller senses generator power output. A temperature sensor 690 and a pressure sensor 692 allow the controller 699 to sense the discharge pressure and temperature leaving the precompressor 688. The controller provides a signal to each fan to control pressure. The fans preferably modulate the blade pitch angle to adjust pressure output. In addition, the controller can turn off individual fans to reduce the pressure output from the precompressor. Air moves freely through non-operating fans, which preferably include a brake to prevent undesirable rotation (freewheeling). The remaining components of FIG. 7 operate in the same manner as described above for FIG. 6.

While the configurations of FIG. 7 and FIG. 6 eliminate any possibility of liquid contact with the air stream downstream of the supercharging fan, other options are possible. For example, a direct-contact liquid-to-air heat exchanger may be used instead of coil. The duct design would have to be much larger in order accommodate this type of heat exchanger without risk of blowing liquid droplets of the surface of the direct-contact heat exchanger. The liquid may be cooled with a cooling tower, chiller or similar device. Direct evaporative cooling and combinations of chilling and evaporative cooling are also options, but not preferred.

Other applications provide additional embodiments. For example, a highly supercharged gas turbine used in coal gasification systems or fuel-cell/gas-turbine combined cycle plants can provide a large increase in output for a low incremental cost. An additional benefit of supercharging is the ability to maintain a constant output that is almost independent of ambient temperature and barometric pressure. These features can further improve the economics of these systems.

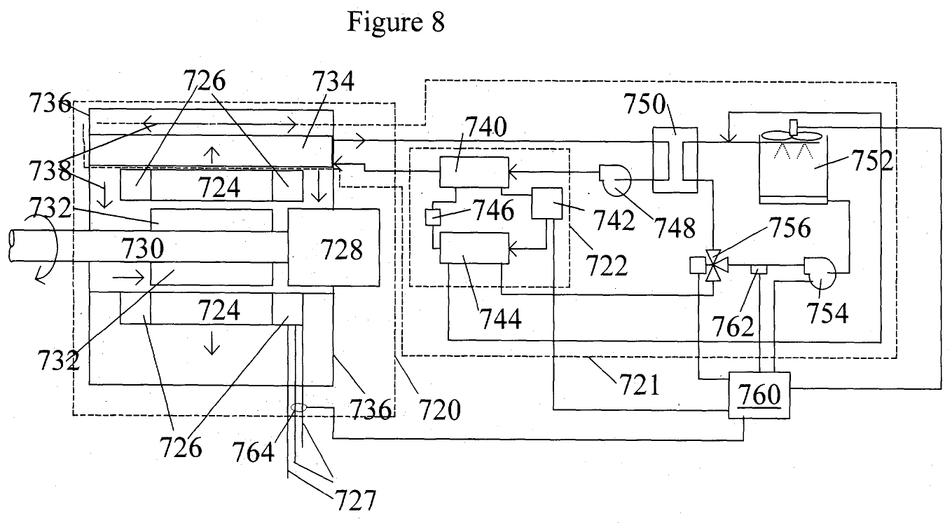

FIG. 8 shows a detail of a preferred embodiment of the invention that is suitable for use with electric generators. This embodiment comprises a generator 720 that is connected to a cooling system 721 that includes a chiller 722. The generator 720 acts as an alternating-current power producer. The chiller 722 serves as a refrigeration system for cooling the generator 720.

The generator is preferably of conventional design, which is shown schematically in FIG. 8. A stator comprises coils 726 that are wrapped around magnetic material 724. The electrical output of the coils is connected to an electrical distribution system 727. A rotor 732 is mechanically attached to a shaft 30 and is electrically connected to an exciter 728. The rotating of the rotor creates a changing magnetic field in the stator, which induces an electrical current in the stator.

The cooling system 721 includes a fluid circuit that comprises cooling coil 734, a heat exchanger 750, a pump 748, and cooler 740. This circuit contains a first fluid that is preferably a liquid such as water or an anti-freeze solution. The cooling coil 734 is part of the generator 720, and the cooler 740 is part of the chiller 722.

The chiller is a conventional vapor-compression machine. In addition to the cooler 740, the chiller 722 comprises a compressor 742, a condenser 744, and an expansion device 746. The compressor 742 pumps refrigerant vapor from the cooler (evaporator) 740 to the condenser 744 where it condenses to form liquid that flashes in expansion device 746 and boils in cooler 740 to create a vapor stream that returns to the compressor 742, to complete the refrigerant circuit.

As shown in FIG. 8, the chiller is water-cooled. When the chiller is operating, a pump 754 moves water through a three-way valve 756 to the condenser 744 through a cooling tower 752 and back to the pump 754. The cooling tower 752 is preferably a wet tower, although a dry tower is an option in cases of limited water availability. The tower is preferably forced convection, but natural convection is also an option. In the case of a power plant with a steam cycle, the tower also may serve as the power plant's condenser in addition to providing cooling for the generator.

For operation of the cooling system 721 without operation of the chiller 722, water from the cooling tower 752 is used to cool the first fluid directly using heat exchanger 750. In this operating mode, the three-way valve 756 is positioned so that the pump 754 moves water through the valve to the heat exchanger 750. Water then flows from the heat exchanger 750 to the cooling tower 752 and back to the pump 754.

The generator 720 is preferably of conventional three-phase design. As shown in FIG. 8, it uses a second fluid 738 for cooling purposes. An enclosure 736 keeps the cooling fluid 738 inside the generator. The second fluid is preferably a gas, such as hydrogen or air, in a closed circuit. Direct cooling of the generator using the first fluid is also possible in which case the second fluid is not necessary. The selection of gas and/or internal cooling system for the generator depends on the relative efficiency, cost, etc. of the design as is found in the prior art.

The embodiment in FIG. 8 can be retrofitted to a generator with a conventional cooling system. A conventional system would typically use water from the cooling tower to cool the first fluid using the heat exchanger 750. The retrofit would add the chiller 722, the three-way valve 756, and the associated piping.

The embodiment preferably includes a controller 760 that automatically operates the system. The controller 760 is in communication with a current sensor 764 and water-temperature sensor 762. The controller uses these inputs to determine the operation of the chiller 722, the pump 748 and pump 754, the cooling tower 752, and the three-way valve 756. When the generator is operating, the controller would operate the tower 752 and the pump 754 and pump 748. If the generator is heavily loaded and the water temperature from the cooling tower is not sufficiently cold, then the controller positions the three-way valve to direct water to the condenser 744 of the chiller 722. On the other hand, if the water temperature from the tower is sufficiently low to provide adequate cooling for the generator without the chiller, then the controller positions the three-way valve to direct water to the heat exchanger 750 and keeps the chiller off.

The controller can also direct the chiller to adjust its chilled liquid temperature setpoint in response to the current flowing through the generator. An adjustable setpoint is generally preferred to reduce chiller energy use, but a constant chilled liquid temperature has the advantage of simplicity and lower first cost and may be preferred in some cases.

Other control options are possible. For example, the controller can sense generator-winding temperatures instead of current to determine the cooling requirements. The controller may also monitor the ambient wet-bulb and dry-bulb temperatures, first fluid temperatures, and other parameters to assist in determining the optimum mode of operation. For power plants with sophisticated controls, controller 760 may be a power-plant control system that includes many other functions such as controlling operation of gas turbines or steam plants.

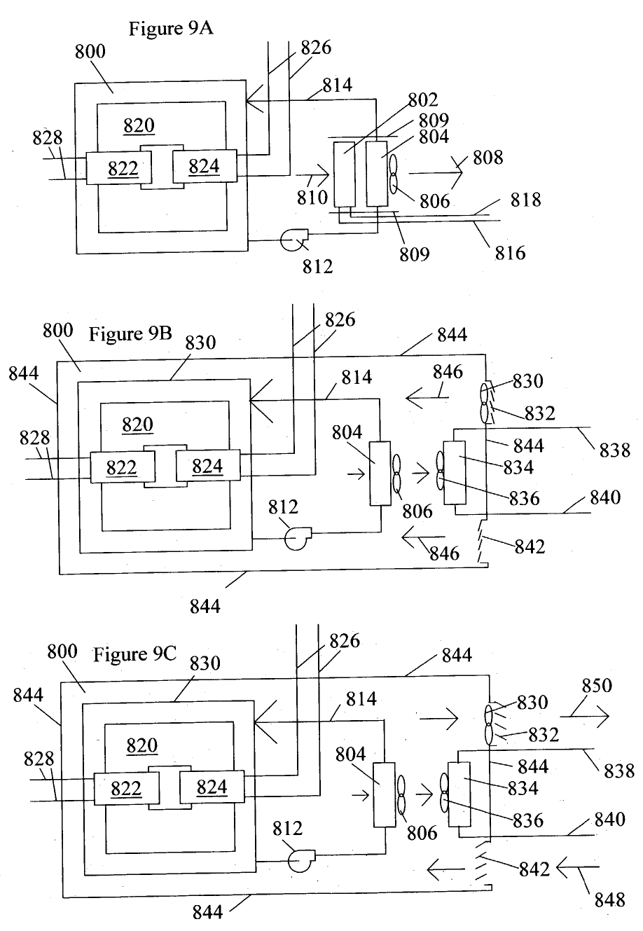

FIG. 9A—Preferred Transformer-cooling Embodiment

FIG. 9A shows a cooling arrangement that is suitable for transformers, and which can also be applied to generators. A transformer 800 is cooled using an evaporator coil 802 that is located upstream of a heat exchanger 804. A fan 806 draws ambient air 810 through the evaporator coil 802 and the heat exchanger 804. The air leaves the fan 804 as a heated air stream 808. A duct 809 provides an enclosure to direct the airflow. Refrigerant flows to the evaporator 802 through a liquid line 818 and leaves as vapor through a suction line 816. A pump 812 moves a liquid from the transformer 800, through the heat exchanger 804 and liquid piping 814 and back to the transformer 800 to create a closed fluid circuit for cooling the transformer.

The transformer 800 is of conventional design. A primary coil 822 and a secondary coil 824 are wrapped around a core 820 that is composed of laminated magnetic material such as silicon steel. While the core needs to provide a complete magnetic circuit, the exact geometry of the optimum core depends on the economics and packaging constraints and other factors as is found in the prior art. A first conductor 828 is connected the primary coil 828 and second conductor 826 is connected to the secondary coil. Alternating current that flows through the primary coil 822 induces a changing magnetic field in the core 820 that creates a current in the secondary winding 824. The secondary winding acts as a power producer to supply electrical energy through the second conductor 826.

The primary and secondary windings normally have a different number of turns, which allows the transformer to step up or step down the voltage from the primary to secondary winding. While the primary winding normally drives the power output of the secondary winding, the power may flow in either direction. The selection which winding is primary and which is secondary is somewhat arbitrary; the labels may be switched without changing the operation transformer.

FIGS. 9B and 9C—Alternate Transformer-cooling Embodiment

FIGS. 9B and 9C show two operating modes for an alternate embodiment for transformer cooling. The transformer 800 and its associated components are the same as in FIG. 9A and the description will not be repeated here. The difference from FIG. 9A is in the cooling system. As shown in FIG. 9B, an enclosure 844 surrounds the transformer 800, including the heat exchanger 804. The enclosure should prevent excessive mixing of air inside the enclosure with ambient air outside the enclosure. A cooler 834 and a fan 836 supply cooled air 846 to the inside of enclosure 844. The cooler receives lower-enthalpy fluid 838 and higher-enthalpy fluid 840 exits the cooler. The low-enthalpy fluid preferably comprises refrigerant liquid and the higher-enthalpy fluid is preferably refrigerant vapor. For the refrigeration operating mode in FIG. 9B, a fan 830 is not operating and dampers 832 and 842 are closed.

FIG. 9C shows the same configuration as in 9B but with a non-refrigeration operating mode. In this mode, cooling is supplied by operating fan 830, which moves ambient air 848 through the volume inside enclosure 844. Air exits the enclosure as air stream 850. The dampers 842 and 832 are preferably back-draft dampers that act as check valves. These dampers open automatically in response to operation of fan 830 and close when the fan 830 is not operating.

For the embodiments in FIGS. 9B and 9C, the transformer can use natural convection for internal cooling, in which case pump 812 and fan 806 would not be included. For natural convection cooling, a most of the thermal energy would exit through the transformer enclosure 844, which would normally include fins to enhance heat transfer to the air and can eliminate the need for a separate heat exchanger 804. For this type of transformer, the embodiment of FIGS. 9B and 9C is the preferred cooling configuration. In addition to cooling transformers, the embodiments in FIGS. 9A, 9B, and 9C are also suitable for cooling generators.

Theory of Operation for Supercharging Without Downstream Expander:

Table 1 shows an example of the advantages of high-pressure supercharging compared to the limited supercharging found in the prior art. The example is based on a simple-cycle turbine that is located in the southwestern US. The table shows that increasing the supercharging pressure can provide a much greater increase in capacity than is available from systems found in the prior art. The Bronicki column shows the output available using the 1.15 pressure ratio combined with cooling to ambient temperature as taught in the Bronicki patent discussed above. For this example, the Bronicki approach shows little improvement compared to simple evaporative cooling, while the present invention without a downstream expander shows a large increase in output. The assumed 220 MW maximum turbine output corresponds to approximately 1.2 to 1.25 times the ISO sea-level rating.

TABLE 1
Projected Performance Comparison

| Assumptions: | | |
|---|---|---|
| Ambient dry bulb | 110 | deg F |
| Ambient wet-bulb | 70 | deg F |
| Barometric pressure | 13.75 | psia |

| | | | |
|---|---|---|---|
| | Evap. | | Present |
| Base | Cooling | Bronicki | Invention |

| | | | | | |
|---|---|---|---|---|---|
| Turbine inlet pressure | 13.75 | 13.75 | 15.81 | 19.0 | psia |
| Supercharger pressure | 1 | 1 | 1.15 | 1.38 | |
| ratio | | | | | |
| Turbine inlet temperature | 110 | 74 | 110 | 98 | deg. F. |
| Turbine output | 134 | 153 | 165 | 220 | MW |
| Fan power | 0 | 0 | 6.8 | 20.5 | MW |
| Net output | 134 | 153 | 158 | 200 | MW |

The example in Table 1 assumes little or no change in the design of the gas turbine. Even higher supercharging pressures can be desirable with relatively minor changes to the turbine design to accommodate a higher torque output.

A key feature of the controls allow for maximum output at wide range of conditions. For installations with a fixed combustion-turbine torque limit or other fixed limit exists, then the controls would maintain a flat output of the combustion turbine that is consistent with this limit. For case with an air-cooled generator with a capacity limit that varies with ambient temperature, then the turbine output may be modulated to correspond to this variable limit. For a supercharger with a cooler, the preferred strategy is to control the pressure of the supercharging fan to maintain constant turbine output.

Alternatively, the controls can modulate the cooler to maintain a constant turbine inlet temperature and pressure for a range of ambient conditions. Once the cooler is effectively off, any further drop in ambient temperature is accommodated by changing the output pressure of the precompressor to maintain constant turbine output. Control of the air temperature may be preferred in the case of a combined-cycle power plant, since it can provide a higher turbine exhaust temperature for the same turbine output. Operation of the cooler may also be controlled to prevent formation of ice or frost either in the ductwork upstream of the combustion turbine or in an external evaporative cooler or cooling tower.

For the case where no cooling is used downstream of the fan, pressure control is the primary control. The pressure is modulated maintain a constant turbine output.

Summary of Operation for Supercharging with Downstream Expander:

For supercharging with the downstream expander, much greater capacity is possible for a given combustion turbine. For the case from Table 1 a turbine capacity of 440 MW is possible by increasing the inlet pressure to 38 psia and the outlet pressure leaving the gas turbine to 27.5 psia, assuming the same turbine inlet air temperature. In addition, a high level of supplemental firing combined with an increase in the design steam cycle can provide a stream-cycle capacity that is equal to or greater than that of the simple-cycle turbine. The result is a combined cycle system with a capacity that approaches 1000 MW using a single F-class combustion turbine. The cost for this output should be much lower than that of conventional combined-cycle plants of similar capacity and could approach that of simple-cycle plants.

Design heat rate should be comparable to that of conventional combined-cycle systems. In addition the present invention provides the opportunity to modulate capacity by varying operating pressures rather than firing temperatures, which should allow for operation over a wide range of operating conditions at close to design efficiency.

Operation for Transformer and Generator Cooling:

The use of a refrigeration system for cooling generators and transformers allows for a large increase in capacity. For a typical air-cooled generator, rated capacity goes down by about 0.2% per ° F. Thus cooling the air by 50° F. gives an increase of rated capacity of 10%. For a 100 MW generator this capacity increase is approximately 10 MW. For a 98% efficient generator, the cooling required is 2 MW=570 tons. With chiller efficiency of 1 kW/ton, the result is that the capacity increase is just under twenty times the power use by the chiller, which means that a large increase in net output is possible. Similar effects are possible with transformers.

This cooling load assumes a closed-circuit cooling system where all the generator losses go into the chiller load. Lower load may be possible for a cooling of inlet air to the generator in a once-through configuration, depending on the ambient air conditions and air temperature change through the generator.

This generator capacity is particularly valuable since it is possible to increase output of existing equipment without the expense and downtime required for replacement. An added advantage is that the supplemental cooling and associated refrigeration energy use can be utilized only when required by combinations of high ambient temperature and high capacity requirement.

Preferred Complete Generation System:

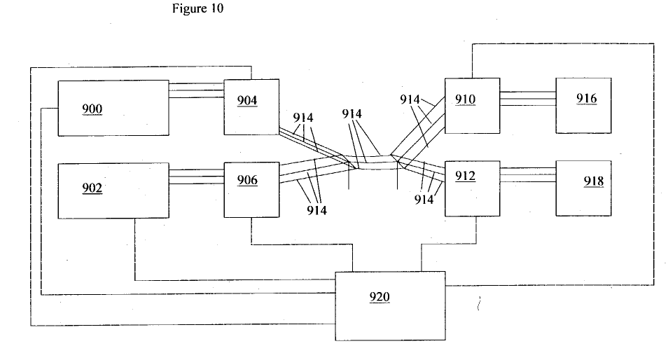

FIG. 10 shows a preferred embodiment of a complete power generation and transmission system. Output from a first highly supercharged gas-turbine plant 900 is electrically connected to a first step-up transformer 904. A second highly supercharged combined cycle plant 902 is likewise connected to a second step-up transformer 906. Electrical transmission lines 914 connect the output of the step-up transformers to step-down transformers 910 and 912 that are connected to electrical loads 916 and 918 respectively. A controller 920 is in communication with the output of the gas-turbine power plants 900 and 902 and the transformers 904, 906, 910, and 912.

For illustration purposes, the first highly supercharged gas-turbine plant 900 is preferably of the type described in FIG. 3. This plant would preferably be of new construction. The second highly supercharged gas-turbine plant is preferably of the type in FIG. 6. This plant is preferably an existing plant that has supercharging and generator cooling added to provide extra output. The transformers are preferably cooled using refrigeration systems as are described in FIGS. 9A, 9B, and 9C. The cooling systems may be added to existing transformers to increase output or they may be included in new transformers.

The controller 920 preferably senses system load conditions and signals need for operation of the gas-turbine plants 900 and 902. The plants can turn on or off and modulate output in response to changes in electrical demand and/or prices. The plant output is preferably modulated by varying the amount of supercharging and duct firing as described earlier. Transformer refrigeration is preferably activated in response to changes in electrical load and ambient temperature or winding temperatures.

An advantage of this generation system is its ability to efficiently respond to changes in load quickly and efficiency. Variable supercharging pressure varies capacity without requiring a significant change in operating temperatures. This feature allows for a large, rapid change in capacity by eliminating time delays associated with heating or cooling the large thermal mass of power plant components. It also eliminates mechanical stress associated with rapid changes in component operating temperatures. This reduced mechanical stress can extend equipment life and allows rapid change in output without thermal shock to critical components.

Advantages

The present invention overcomes many problems found in the prior art. Specific advantages include:

1) Greatly increased power output for a given combustion turbine,

2) Excellent efficiency over broad range of operating conditions,

3) Low cost for the additional output,

4) Extremely high levels of supercharging are possible with excellent efficiency,

5) Improved controls and plant configuration maintain high expander performance,

6) Ability to use existing designs of combustion turbines with a minimum of changes,

7) High reliability because of the use of well-proven components,

8) Small space requirements,

9) Great flexibility in design options,

10) System can be implemented quickly without a long development program,

11) Ability to increase output of existing power generation and transmission systems without equipment replacement,

12) Rapid changes in output without thermal shock, and

13) Ability to compensate for effects of high ambient temperature on component performance.

The invention having been thus described, it will be apparent to those skilled in the art that the same may be varied in many ways without departing from the spirit of the invention. Any and all such modifications are intended to be included within the scope of the following claims.

1. A highly supercharged gas-turbine power-producing system comprising:
a. a gas turbine that comprises a compressor that receives an air stream from an inlet, compresses said air stream to provide pressurized air, a combustor that receives said pressurized air and supplies thermal energy to said pressurized air to produce a heated air stream, and a first expander that receives said heated air stream and is caused to rotate by said heated air stream, and a drive shaft that is connected to said compressor and rotated by rotation of said first expander, and
b. a supercharger that comprises a precompressor with a design pressure ratio greater than about 1.15 that supplies pre-pressurized air to the inlet of said gas turbine and thereby provides an increase in power output of said gas turbine relative to an air stream at atmospheric pressure.

2. The highly supercharged gas-turbine power-producing system of claim 1 further comprising a cooler that lowers the temperature of air leaving said precompressor to a value that is not lower than about the dewpoint temperature of air leaving the precompressor.

3. The highly supercharged gas-turbine power-producing system of claim 2 wherein the design pressure ratio of said precompressor is at least 1.20.

4. The highly supercharged gas-turbine power-producing system of claim 2 wherein said cooler does not add moisture to the air leaving the precompressor.

5. The highly supercharged gas-turbine power-producing system of claim 1 further comprising a pressure-reducing means located between an air stream outlet of said gas turbine and the atmosphere.

6. The highly supercharged gas-turbine power-producing system of claim 5 wherein said precompressor has a controllably variable output pressure.

7. The highly supercharged gas-turbine power-producing system of claim 6 wherein said pressure reducing means comprises an expander.

8. The highly supercharged gas-turbine power-producing system of claim 7 wherein said expander comprises a variable-pitch axial-flow expander.

9. The highly supercharged gas-turbine power-producing system of claim 6 wherein said pressure-reducing means comprises a damper with a variable flow area that provides a variable resistance to flow.

10. The highly supercharged gas-turbine power-producing system of claim 2 further comprising means for adjusting the cooling capacity of said cooler.

11. The highly supercharged gas-turbine power-producing system of claim 10 wherein said cooler supplies an air temperature to said gas turbine that is approximately constant.

12. The highly supercharged gas-turbine power-producing system of claim 2 wherein said cooler comprises a fogger.

13. The highly supercharged gas-turbine power-producing system of claim 5 wherein said pressure-reducing means comprises an orifice.

14. The highly supercharged gas-turbine power-producing system of claim 13 further comprising a bypass damper that allows exhaust gas to flow around said orifice with lower pressure drop and a controller that controls the operation of said precompressor and said means for bypassing exhaust gas so that when a lower power output is required, said controller opens said bypass damper and does not operate said precompressor and when increased power output is required said controller operates said precompressor and closes said bypass damper.

15. A gas-turbine power plant comprising:
a. a supercharging fan for providing a source of pressurized air;
b. a combustion turbine that comprises a compressor that receives said pressurized air from an inlet and further compresses said pressurized air, a combustor that provides thermal energy to said further pressurized air to heat said further pressurized air, and an expander that receives that heated air and is caused to rotate by said heated air;
c. an electric generator that is connected to an output shaft of said combustion turbine; and
d. a duct that connects said source of pressurized air to the inlet of said combustion turbine, which has a maximum cross-sectional area such that the average gas velocity through the maximum cross-section exceeds about 600 feet per minute.

16. The gas-turbine power plant of claim 15 further comprising a cooler that is enclosed in said duct.

17. The gas-turbine power plant of claim 16 wherein said cooler has a face that is located at an angle with respect to the plane of the cross section of said duct so as to reduce the face velocity of air through said cooler.

18. The gas-turbine power plant of claim 17 wherein said cooler has a wet surface and the face velocity of air through said cooler is selected to prevent liquid carryover from said cooler.

19. The gas-turbine power plant of claim 18 wherein said cooler is a heat pipe.

20. The gas-turbine power plant of claim 19 wherein said cooler is an indirect evaporative cooler.

21. A gas-turbine power plant comprising:
a. a heavy-duty combustion turbine that comprises a compressor and a first expander that share a common shaft which supplies a shaft output and which has an unsupercharged ISO rating of at least 50 MW and design firing temperature of at least about 2000° F.,
b. a generator which receives said shaft output from said heavy-duty combustion turbine, and
c. pressure-reducing means located downstream of said first expander for maintaining outlet pressure of said first expander to a value the same or slightly less than inlet pressure of said compressor.

22. The gas-turbine power plant of claim 21 further comprising a precompressor that supplies pressurized air to the compressor of said gas turbine.

23. The gas-turbine power plant of claim 22 wherein said pressure-reducing means comprises a second expander that is on a shaft that is separate from said common shaft.

24. The gas-turbine power plant of claim 23 further comprising a shaft output from said second expander that is connected to an electromechanical transducer.

25. The gas-turbine power plant of claim 24 wherein said second expander drives said precompressor.

26. The gas-turbine power plant of claim 22 wherein said pressure-reducing means comprises an orifice.

27. A gas-turbine power plant comprising:
a. a compressor that produces a stream of high-pressure air,
b. a combustor that heats the high-pressure air stream to produce a stream of high-temperature, high-pressure gas,
c. an expander that expands the high-temperature, high-pressure gas stream to produce mechanical work that drives said compressor,
d. a heat-recovery steam generator that receives a high-temperature gas stream from said expander at a pressure that is at a intermediate pressure that is substantially above atmospheric and substantially below that of air exiting from said compressor, and
e. a second expander that receives a gas stream from said heat-recovery steam generator and expands it to a pressure that is approximately atmospheric.

28. The gas-turbine power plant of claim 27 further comprising a precompressor that supplies a pressurized air stream to said compressor.

29. The gas-turbine power plant of claim 28 further comprising a cooler that lowers the temperature of air before it enters said compressor.

30. The gas-turbine power plant of claim 29 wherein said cooler comprises a feedwater heater that warms water before it enters said heat-recovery steam generator.

31. The gas-turbine power plant of claim 30 wherein said cooler comprises a heat exchanger between an air stream upstream of said compressor and a gas stream entering said second expander.

32. The gas-turbine power plant of claim 29 wherein said cooler comprises means for evaporating water into the air before it enters said compressor.

33. A gas-turbine power plant comprising:
a. a combustion turbine that comprises a compressor, a combustor, and a first expander, and a shaft output that is connected to said first expander,
b. a generator connected to said shaft output,
c. a precompressor that pressurizes air to inlet of said combustion turbine, and
d. a torque-limiting device that is connected between the shaft output of said gas turbine and said generator so as to prevent transient overload of said shaft output.

34. A gas-turbine power plant comprising:
a. a gas turbine,
b. a precompressor,
c. a generator with an input shaft that receives power from said gas turbine and an output shaft that drives said precompressor, and
d. a first clutch that drivingly connects said output shaft from said generator to said precompressor so that said clutch engages to drive said precompressor when supercharging is required and said clutch disengages to allow operation of said gas turbine without said precompressor when supercharging is not required.

35. The gas-turbine power plant of claim 34 further comprising a speed reducer between said precompressor and said the shaft output from said generator.

36. The gas-turbine power plant of claim 35 further comprising a bypass damper that allows air to flow around said precompressor when supercharging is not required.

37. The gas-turbine power plant of claim 36 further comprising a brake that prevents rotation of said precompressor when supercharging is not required.

38. The gas-turbine power plant of claim 36 wherein said precompressor comprises at least two compressor stages with a first stage connected to said output shaft from said generator by means of said first clutch and a second stage is connected to an output shaft from said first stage by a second clutch so that when a lower supercharging pressure is required said first clutch is engaged to drive said first compressor stage and when a higher supercharging pressure is required said second clutch engages so as to drive said second compressor stage.

39. The gas turbine power plant of claim 34 wherein said precompressor is a radial-flow device.

40. A combined-cycle power plant comprising:
a. a gas turbine,
b. a precompressor that supplies pressurized air to said gas turbine,
c. a steam cycle that comprises a heat-recovery steam generator receives hot gas from said gas turbine, and
d. a duct burner with a design firing temperature of at least about 1400° F. that is located between said gas turbine and said steam cycle and that heats said hot gas from said gas turbine.

41. The combined-cycle power plant of claim 40 wherein said steam cycle is a single-pressure steam cycle.

42. The combined-cycle power plant of claim 41 wherein said the design firing temperature of said duct burner is at least about 1800° F.

43. The combined-cycle power plant of claim 42 further comprising an expander that is located between said duct burner and said heat-recovery steam generator.

44. The combined-cycle power plant of claim 42 further comprising an expander that located downstream of said heat-recovery steam generator.

45. The combined-cycle power plant of claim 40 further comprising means for varying pressure output of said precompressor so as to vary the output of said power plant.

46. A method of enhancing output of a gas turbine power plant comprising:
a. pressurizing an air stream to a pressure ratio greater than about 1.15,
b. cooling said air stream to a temperature that is above about the dewpoint temperature of said air stream, and
c. supplying said cooled, pressurized air stream to the inlet of a gas turbine.

47. The method of claim 46 further wherein said cooling results in a temperature that is above about the dewpoint temperature of the air.

48. The method of claim 46 wherein said pressure ratio for pressurizing said air stream is above about 1.5.

49. The method of claim 48 further comprising the step of providing a pressure drop between said gas turbine and the atmosphere.

50. The method of claim 49 wherein said pressure drop is provided by an expander.

51. The method of claim 49 wherein said pressure drop is provided by an orifice.

52. An electrical power-producing system comprising:
a. an alternating-current power producer that comprises a winding that is wrapped around a magnetic core;
b. means for producing a changing magnetic field through said magnetic core,
c. refrigeration means for cooling a refrigerant to a temperature below the ambient wet-bulb temperature by evaporating said refrigerant,
d. a first fluid circuit comprising a first fluid that circulates in a substantially closed loop through said alternating-current power producer, a pumping means for circulating said first fluid through said circuit, and said refrigeration means, and
e. a non-refrigerating cooling means for providing cooling for said first fluid without operation of said refrigeration means;
wherein said means for producing induces an alternating current in said winding of said alternating-current power producer and said refrigeration means cools said closed fluid loop which cools said alternating-current power producer and thereby increases the power output capability of said power producer, and said non-refrigerating cooling means provides auxiliary cooling when said refrigeration means is not operating.

53. The electrical power-producing system of claim 52 wherein said alternating-current power producer is a generator.

54. The electrical power-producing system of claim 52 wherein said alternating-current power producer is a transformer.

55. The electrical power-producing system method of claim 52 wherein said refrigeration means comprises a chiller.

56. The electrical power-producing system method of claim 55 wherein said nonrefrigerating cooling means comprises a heat exchanger between said first fluid and a unrefrigerated fluid and means for moving said unrefrigerated fluid through said heat exchanger.

57. The electrical power-producing system of claim 56 wherein said unrefrigerated fluid is ambient air and said means for moving said unrefrigerated fluid comprises a fan.

58. The electrical power-producing system of claim 56 further comprising a cooling tower and wherein said unrefrigerated fluid is water that is cooled in said cooling tower and said means for moving said unrefrigerated fluid comprises a pump.

59. The electrical power-producing system of claim 56 wherein said heat exchanger is located in said first fluid circuit in series flow arrangement with said refrigeration means.

60. The electrical power-producing system of claim 52 further comprising transmission means between said power producer and an electrical load for transmitting electrical power produced by said power producer to said electrical load.

61. A method for enhancing output of a gas-turbine power plant that comprises a combustion turbine that drives an electric generator, said method comprising the steps of:
pressurizing and cooling inlet air to said combustion turbine;
cooling a fluid to a temperature that is substantially below the turbine inlet air temperature; and
supplying said cooled fluid to said generator so that the capacity of the cooled generator matches the available power output of said combustion turbine.

62. The method of claim 61 wherein said fluid is cooled to a temperature that is below about the wet-bulb temperature of the turbine inlet air.

63. The method of claim 61 wherein said fluid is cooled using a refrigeration system.

64. A gas-turbine power plant comprising:
a. a gas turbine,
b. a generator that is driven by said gas turbine,
c. a supercharging fan that supplies pressurized air to said gas turbine, and
d. a refrigeration system that supplies fluid at a temperature that is below the inlet air to said gas turbine for cooling said generator.

65. A power generation and distribution system comprising:
a. a highly supercharged gas turbine power plant having a design pressure ratio of greater than 1.15;
b. a transformer for receiving electrical power produced by said power plant and modifying a voltage level of said electrical power;
c. a refrigeration system for cooling said transformer; and
d. a controller that modulates the output of said gas turbine power plant in response to changes in system demand, by controlling operation of said refrigeration system and by controlling supercharging of said gas turbine power plant.

66. A highly supercharged gas-turbine power-producing system comprising:
a. a gas turbine that comprises a compressor that receives an air stream from an inlet, compresses said air stream to provide pressurized air, a combustor that receives said pressurized air and supplies thermal energy to said pressurized air to produce a heated air stream, and a first expander that receives said heated air stream and is caused to rotate by said heated air stream, and a drive shaft that is connected to said compressor and rotated by rotation of said first expander,
b. a supercharger that comprises a precompressor with a design pressure ratio greater than about 1.15 that supplies pre-pressurized air to the inlet of said gas turbine and thereby provides an increase in power output of said gas turbine relative to an air stream at atmospheric pressure;
c. a duct that connects said precompressor to the inlet of said gas turbine, which has a maximum cross-sectional area such that the average gas velocity through the maximum cross-section exceeds about 600 feet per minute;
d. a heat-recovery steam generator that receives a high-temperature gas stream from said first expander at a pressure that is at a intermediate pressure that is substantially above atmospheric and substantially below that of air exiting from said compressor, and
e. a second expander that receives a gas stream from said heat-recovery steam generator and expands it to a pressure that is approximately atmospheric.

67. A power-generation and transmission system comprising:
a. at least one gas turbine
b. a precompressor that supplies air pressurized to a pressure ratio greater than about 1.20 to said gas turbine
c. an electric generator that is driven by said gas turbine
d. an electrical power transmission system that comprises a high-voltage power line that receives alternating-current power from said generator and transmits a transformer that supplies electrical power at a reduced voltage to an electrical load.

68. The power-generation and transmission system of claim 67 wherein said pressure ratio of said precompressor is greater than about 1.5.

69. The power-generation and transmission system of claim 68 further comprising a controller that activates operation of said precompressor and said gas turbine in response to increased electrical load on the transmission system.

70. A gas turbine that is suitable for operating with a high level of supercharging comprising:
a. a compressor that pressurizes a stream of air,
b. an expander that extracts work from expanding hot, high-pressure gas to a lower pressure and drive said compressor,
c. an output shaft that is driven by said expander
d. a generator that is mechanically connected to said output shaft
e. a combustor with a design output that is substantially greater than that required to provide a design firing temperature at sea-level barometric pressure and a turbine inlet air temperature of −40° F.

71. The gas turbine of claim 70 wherein the design power output limit of said output shaft is substantially greater than the rated unsupercharged power output of said gas turbine at sea-level barometric pressure and an inlet air temperature of −40° F.
